(19) United States
(12) Patent Application Publication
(10) Pub. No.: US 2006/0022773 A1
(43) Pub. Date: Feb. 2, 2006

(54) Filter, high-frequency module, communication device and filtering method

(76) Inventors: Tomohiro Iwasaki, Osaka (JP); Hiroyuki Nakamura, Osaka (JP); Toshio Ishizaki, Hyogo (JP); Kazuhide Uriu, Osaka (JP)

Correspondence Address: RATNERPRESTIA, P O BOX 980, VALLEY FORGE, PA, 19482-0980, US

(21) Appl. No.: 11/204,185

(22) Filed: Aug. 15, 2005

Related U.S. Application Data
(63) Continuation of application No. 10/651,182, filed on Aug. 28, 2003.

(30) Foreign Application Priority Data
Aug. 30, 2002 (JP) 2002-254334

(51) Int. Cl. H01P 1/203

(52) U.S. Cl. 333/204

(57) ABSTRACT

A filter having an unbalanced terminal, a first stripline resonator of which one end is connected to the unbalanced terminal, a second stripline resonator placed to be electromagnetically coupled to the first stripline resonator, and balanced terminals of which both ends are connected to the second stripline resonator, wherein the first stripline resonator and the second stripline resonator are connected by at least one impedance element, and the second stripline resonator is a ½ wavelength resonator substantially having ½ the length of a wavelength of a resonance frequency.

This application is a continuation of U.S. patent application Ser. No. 10/651,182, filed Aug. 28, 2003, the contents of which are incorporated herein by reference.

### BACKGROUND OF THE INVENTION

1. Field of the Invention

The present invention relates to an input-output filter as unbalanced input (output)-balanced output (input) used for high-frequency wireless applications, and a high-frequency module, a communication device and a filtering method utilizing it.

2. Related Art of the Invention

In recent years, small-sized and high-performance filters are in increasing demand as communication devices are miniaturized. Specifically, ceramic laminated filters suited to smaller sizes and lower profiles have been increasingly used.

An equivalent circuit of a laminated band-pass filter (BPF) of an unbalanced input-output type as one of the laminated filters is shown in FIG. 18.

According to this configuration, two stripline resonators 181a and 181b substantially having ¼ wavelength (electrical length) of resonant frequencies for mutually electromagnetic coupling are placed by shorting one end thereof respectively. An open end of the stripline resonator 181a has an unbalanced terminal 184a connected thereto via a coupling capacitance 182a, and the open end of the stripline resonator 181b has an unbalanced terminal 184b connected thereto via a coupling capacitance 182b. An inter-section coupling capacitance 183 is connected between the open ends of the two ¼-wavelength stripline resonators 181a and 181b to form the unbalanced input-output type band-pass filter.

An example of rendering it as a laminated structure will be described. As shown in FIG. 19, six dielectric layers 1901, 1902, 1903, 1904, 1905 and 1906 are laminated. A pair of ¼-wavelength stripline electrodes 191a and 191b each having a short circuit end are placed in the dielectric layer 1903 sandwiched between the dielectric layers 1901 and 1905 in which shield conductors 195a and 195b are placed. As for the dielectric layer 1904, input-output electrodes 192a and 192b are placed on the open end sides of the respective ¼-wavelength stripline electrodes 191a and 191b so as to be electrostatically coupled thereto. As for the dielectric layer 1902, an inter-section coupling electrode 193 is placed between the ¼-wavelength stripline electrodes 191a and 191b so as to be electrostatically coupled to the stripline electrodes 191a and 191b respectively.

The pair of ¼-wavelength stripline electrodes 191a and 191b mutually coupled electromagnetically, and each of the input-output electrodes 192a, 192b and inter-section coupling electrode 193 and an electrode opposing portion of the ¼-wavelength stripline electrodes 191a and 191b are forming parallel plate capacitors and the coupling capacitance together. This coupling capacitance is corresponding to the input-output coupling capacitance 182a, 182b and inter-section coupling capacitance 183 in FIG. 18. The inter-section coupling capacitance 183 is intended to have an attenuation pole generated by a transmission characteristic. Thus, the inter-section coupling between the stripline resonators 181a and 181b is performed by a combination of the electromagnetic coupling and electrostatic coupling.

As for this configuration, however, miniaturization of the device is limited because the length of the stripline resonators 181a and 181b is the ¼-wavelength. In recent years, there is a proposal, concerning this problem, of a technique for lowering a resonant frequency as to the stripline resonators of the same length by rendering loading capacity electrodes 200a and 200b in FIG, 20 opposed to the open ends of the stripline electrodes 191a and 191b and forming a loading capacity. As shown in FIG. 21, there is also a proposal of the technique for series-connecting at least two stripline electrodes (SIR: Stepped Impedance Resonators) 217a and 218a of different stripline widths, and series-connecting stripline electrodes 217b and 218b so as to convert the impedance of the resonators and lower the resonant frequency.

Next, a balun (unbalance-to-balance converter) for mutually converting a balanced signal and an unbalanced signal of the input or output will be described.

The balanced signal outputted from the balun has the characteristic of ideally having an amplitude difference of 0 dB and a phase difference of 180 degrees in a necessary band (refer to Japanese Patent Laid-Open No. 2003-60409, Japanese Patent Laid-Open No. 2000-236227, Japanese Patent Laid-Open No. 2002-353834 and Japanese Patent Laid-Open No. 2003-87008 for instance). Although a coaxial structure was adopted to the balun in the past, it is miniaturized and shortened in height by using the laminated structure in recent years. FIG. 22 shows an equivalent circuit diagram of such a balun.

In the configuration shown in FIG. 22, there are a stripline resonator 2201 having substantial ½ wavelength of the resonant frequency and two stripline resonators 2202a and 2202b having substantial ¼ wavelength of the resonant frequency, and the stripline resonators 2202a and 2202b are placed in parallel with the stripline resonator 2201 to be electromagnetically coupled respectively. One end of the ½ wavelength stripline resonator 2201 is connected with an unbalanced terminal 2203, the two ¼ wavelength stripline resonators 2202a and 2202b have short circuit ends formed by ends thereof respectively and a pair of balanced terminals 2204a and 2204b connected to the other ends thereof respectively. The signal inputted from an unbalanced terminal 2203a is ideally rendered as the balanced signal of the amplitude difference of 0 dB and phase difference of 180 degrees by the ½ wavelength stripline resonator 2201 and two ¼ wavelength stripline resonators 2202a and 2202b so as to be outputted from the balanced terminals 2204a and 2204b respectively.

FIG. 23 shows an example of the laminated structure of the balun. In FIG. 23, one ½ wavelength stripline electrode 2301 and two ¼ wavelength stripline electrodes 2302a and 2302b are formed in parallel therewith in a dielectric layer 2313 sandwiched between the dielectric layers 2311 and 2314 in which shield conductors 2308a and 2308b are placed, and an unbalanced input (output) electrode 2303 and balanced output (input) electrodes 2304a and 2304b are formed in a dielectric layer 2312. One end of the ½ wavelength stripline electrode 2301 is rendered as the open end, and the other end thereof is connected to the unbalanced input (output) electrode 2303 via the coupling capacitance. One end of each of the ¼ wavelength stripline electrodes 2302a and 2302b is connected to a shield conductor 2308b via internal via conductors 2309a and 2309b to form the short circuit ends, and the other end of each of them is connected to balanced output (input) electrodes 2304a and 2304b via the coupling capacitance. The ½ wavelength stripline electrode 2301 and ¼ wavelength stripline electrodes 2302a and 2302b are mutually coupled electromagnetically.

Next, an example of a filter configuration of the unbalanced input (output)-balanced output (input) type in the past will be described.

As shown in FIG. 24, in the unbalanced-balanced filter configuration widely used in the high-frequency circuit of the wireless applications and so on, a filter device 241 such as an unbalanced input-output laminated filter is externally connected to a balanced-unbalanced converter 242 such as a laminated balun so as to constitute a desired filter.

According to the above configuration, however, there is a limit to the miniaturization because, as it is constituted by using the two devices of the laminated filter and balun using the stripline resonators, the device size becomes large.

As described in Japanese Patent Laid-Open No. 2002-353834, there is a proposal of the configuration wherein the filter and balun are formed in a layered product so as to realize the filter and balun functions with one device. Such a configuration can certainly make the device size in a planar direction smaller. However, the height is increased by forming the two devices of the filter and balun in a laminated direction. To be more specific, components of the two devices of the filter and balun are laminated and used as the components as-is, and so the overall volume cannot be rendered smaller. As for the manufacturing process, both the lamination steps of the filter and of the balun are required so that the overall laminating process is not reduced.

Japanese Patent Laid-Open No. 2003-60409 describes the balun wherein, in the pass band, the two signals outputted from the balanced terminals ideally have the amplitude difference of 0 dB and phase difference of 180 degrees and its amplitude characteristic has an attenuation band in a double wave area other than the pass band. At a glance, as its characteristic, the balun seems to have the characteristic of the filter. However, such a balun cannot have the attenuation band or attenuation pole provided in a desired frequency range. To obtain such an attenuation characteristic, it is inevitable to externally connect a filter. Or else, it is general to use a surface acoustic wave filter having a function of converting from unbalance to balance.

Japanese Patent Laid-Open No. 2000-236227 describes the balun wherein a low-pass filter is constituted on one of the balanced terminals and a high-pass filter is constituted on the other balanced terminal so that the phase difference of 180 degrees is realized by rotating the phase by 90 degrees on each filter. This balun also has the pass band and the characteristic like the filter, but it does not have the attenuation pole. Therefore, it is inevitable, none the less, to externally connect a filter in order to obtain the attenuation characteristic in the desired frequency range.

In the case of connecting the balun and filter of the past technology, there is a problem that, as each of them includes a loss in the pass band, the loss is increased by combining them.

### SUMMARY OF THE INVENTION

In consideration of the problems, an object of the present invention is to provide the small-sized and high-performance filter having the balun function, and the high-frequency module, communication device utilizing it and filtering method thereof.

The 1^{st} aspect of the present invention is a filter having:

an unbalanced terminal;

a first stripline resonator of which one end is connected to said unbalanced terminal;

a second stripline resonator placed to be electromagnetically coupled and connected to said first stripline resonator via at least one impedance element; and

a balanced terminal which are connected to both ends of said second stripline resonator, wherein said second stripline resonator is a ½ wavelength resonator having substantial ½ length of a wavelength of a desired resonance frequency.

The 2^{nd} aspect of the present invention is the filter according to the 1^{st} aspect of the present invention, wherein said impedance elements are:

a first capacity element for connecting a portion on said first stripline resonator having a predetermined distance from one end thereof to a portion on said second stripline resonator having a predetermined distance from either one of both ends thereof; and

a second capacity element for connecting a portion on said first stripline resonator having a predetermined distance from the other end thereof to a portion on said second stripline resonator having a predetermined distance from the other end thereof;

said unbalanced terminal and one end of said first stripline resonator are connected via a first matching element;

said balanced terminal and one end of said second stripline resonator are connected via a second matching element;

said balanced terminal and the other end of said second stripline resonator are connected via a third matching element; and

said first capacity element and said second capacity element have a capacity for forming an attenuation pole outside a pass band thereof under said electromagnetic connection between said first stripline resonator and said second stripline resonator.

The 3^{rd} aspect of the present invention is the filter according to the 1^{st} aspect of the present invention, wherein said impedance elements are:

a first inductive element for connecting the portion on said first stripline resonator having the predetermined distance from one end thereof to the portion on said second stripline resonator having the predetermined distance from either one of both ends thereof; and

a second inductive element for connecting the portion on said first stripline resonator having the predetermined distance from the other end thereof to the portion on said second stripline resonator having the predetermined distance from the other end thereof;

said unbalanced terminal and one end of said first stripline resonator are connected via a first matching element;

said balanced terminal and one end of said second stripline resonator are connected via a second matching element;

said balanced terminal and the other end of said second stripline resonator are connected via a third matching element; and

said first inductive element and said second inductive element have an inductance for forming an attenuation pole outside a pass band thereof under said electromagnetic connection between said first stripline resonator and said second stripline resonator.

The 4^{th} aspect of the present invention is the filter according to the 1^{st} aspect of the present invention, wherein it further has a third stripline resonator placed to be electromagnetically connected to said second stripline resonator, and said second stripline resonator and said third stripline resonator are connected by at least one impedance element.

The 5^{th} aspect of the present invention is the filter according to the 4^{th} aspect of the present invention, wherein said impedance elements for coupling said second stripline resonator to said third stripline resonator are:

a third capacity element for connecting a portion on said second stripline resonator having a predetermined distance from one end thereof to a portion on said third stripline resonator having a predetermined distance from either one of both ends thereof; and

a fourth capacity element for connecting a portion on said second stripline resonator having a predetermined distance from the other end thereof to a portion on said third stripline resonator having a predetermined distance from the other end thereof, and said third capacity element and said fourth capacity element have a capacity for forming an attenuation pole outside a pass band thereof, in collaboration with at least one of said impedance elements for connecting said first stripline resonator to said second stripline resonator, under said electromagnetic connection between said first stripline resonator and said second stripline resonator and under said electromagnetic connection between said second stripline resonator and said third stripline resonator.

The 6^{th} aspect of the present invention is the filter according to the 4^{th} aspect of the present invention, wherein said impedance elements for coupling said second stripline resonator to said third stripline resonator are:

a third inductive element for connecting a portion on said second stripline resonator having a predetermined distance from one end thereof to a portion on said third stripline resonator having a predetermined distance from either one of both ends thereof; and

a fourth inductive element for connecting a portion on said second stripline resonator having a predetermined distance from the other end thereof to a portion on said third stripline resonator having a predetermined distance from the other end thereof, and

said third inductive element and said fourth inductive element have an inductance for forming an attenuation pole outside a pass band thereof, in collaboration with at least one of said impedance elements for connecting said first stripline resonator to said second stripline resonator, under said electromagnetic connection between said first stripline resonator and said second stripline resonator and under said electromagnetic connection between said second stripline resonator and said third stripline resonator.

The 7^{th} aspect of the present invention is the filter according to any one of the 2^{nd}, the 3^{rd}, the 5^{th} and the 6^{th} aspects of the present invention, wherein said predetermined distance is 0.2 times or less of a wavelength of a resonance frequency.

The 8^{th} aspect of the present invention is the filter according to the 2^{nd} or the 3^{rd} aspects of the present invention, wherein at least one of said first, second and third matching elements can interrupt a DC component.

The 9^{th} aspect of the present invention is the filter according to the 2^{nd} aspect of the present invention, wherein said first stripline resonator and said second stripline resonator are formed as electrodes on a surface of or inside a third dielectric layer;

said first capacity element is formed among a first electrode placed on the surface of or inside a second dielectric layer adjacent to said third dielectric layer, the electrode forming said first stripline resonator and the electrode forming said second stripline resonator;

said second capacity element is formed among a second electrode placed on the surface of or inside said second dielectric layer, the electrode forming said first stripline resonator and the electrode forming said second stripline resonator;

said first matching element is formed between a third electrode placed on the surface of or inside said second dielectric layer and the electrode forming said first stripline resonator, said second matching element is formed between a fourth electrode placed on the surface of or inside said second dielectric layer and the electrode forming said second stripline resonator, and said third matching element is formed between a fifth electrode placed on the surface of or inside said second dielectric layer and the electrode forming said second stripline resonator;

said third dielectric layer and said second dielectric layer are sandwiched by a first dielectric layer having a first shield conductor placed on the surface thereof or inside it and a fourth dielectric layer having a second shield conductor connected to said first shield conductor placed on the surface thereof or inside it; and

said first shield conductor and said second shield conductor are connected by having a predetermined impedance.

The 10^{th} aspect of the present invention is the filter according to the 9^{th} aspect of the present invention, wherein:

said third dielectric layer is laminated on said first dielectric layer;

said fourth dielectric layer is laminated on said second dielectric layer; and

a longitudinal size of said second shield conductor is larger than the length of said first stripline resonator to the extent that, under said predetermined impedance, an attenuation pole is formed outside its pass band.

The 11^{th} aspect of the present invention is the filter according to the 1^{st} aspect of the present invention, wherein said first stripline resonator and said second stripline resonator are formed as electrodes on a surface of or inside a third dielectric layer;

said first capacity element is formed among a first electrode placed on the surface of or inside a second dielectric layer adjacent to said third dielectric layer, the electrode forming said first stripline resonator and the electrode forming said second stripline resonator;

said second capacity element is formed among a second electrode placed on the surface of or inside said second dielectric layer, the electrode forming said first stripline resonator and the electrode forming said second stripline resonator;

said first matching element is formed between a third electrode placed on the surface of or inside said second dielectric layer and the electrode forming said first stripline resonator, said second matching element is formed between a fourth electrode placed on the surface of or inside said second dielectric layer and the electrode forming said second stripline resonator, and said third matching element is formed between a fifth electrode placed on the surface of or inside said second dielectric layer and the electrode forming said second stripline resonator;

said third dielectric layer and said second dielectric layer are sandwiched by a first dielectric layer having a first shield conductor placed on the surface thereof or inside it and a fourth dielectric layer having a second shield conductor connected to said first shield conductor placed on the surface thereof or inside it;

said first shield conductor and said second shield conductor are connected by having a predetermined impedance; and

said predetermined impedance is low enough to have no attenuation pole formed inside or outside its pass band.

The 12^{th} aspect of the present invention is a high-frequency module wherein a semiconductor device for performing a balance operation is laminated or internally layered in the filter according to the 9^{th} aspect of the present invention.

The 13^{th} aspect of the present invention is a communication device having an antenna, a transmitting circuit connected to said antenna and a receiving circuit connected to said antenna, wherein at least one of said transmitting circuit and said receiving circuit has the filter according to the 1^{st} aspect of the present invention.

The 14^{th} aspect of the present invention is a filtering method having:

a step of conveying an unbalanced signal inputted to an unbalanced terminal to a first stripline resonator;

a step of electromagnetically conveying the signal conveyed to said first stripline resonator to a second stripline resonator placed adjacent to said first stripline resonator;

a step of conveying the signal conveyed to said first stripline resonator to said second stripline resonator via at least one impedance element; and

a step of conveying as a balanced signal the signal conveyed to said second stripline resonator to a balanced terminal connected to both ends of said second stripline resonator.

It can provide the small-sized and high-performance filter having the balun function, and the high-frequency module, communication device utilizing it and filtering method thereof.

### BRIEF DESCRIPTION OF THE DRAWINGS

FIG. 1 is an equivalent circuit diagram of an unbalanced-balanced laminated band-pass filter according to a first embodiment of the present invention;

FIG. 2 is an exploded perspective view of the unbalanced-balanced laminated band-pass filter according to the first embodiment of the present invention;

FIG. 3(a) is a diagram showing a transmission characteristic of an unbalanced-balanced laminated band-pass filter according to the first embodiment of the present invention;

FIG. 3(b) is a diagram showing a balance characteristic of the unbalanced-balanced laminated band-pass filter according to the first embodiment of the present invention;

FIG. 3(c) is a diagram showing a balance characteristic of the unbalanced-balanced laminated band-pass filter according to the first embodiment of the present invention.

FIG. 4 is an equivalent circuit diagram of a three-section unbalanced-balanced laminated band-pass filter according to the first embodiment of the present invention;

FIG. 5(a) is an equivalent circuit diagram of the unbalanced-balanced laminated band-pass filter for controlling the frequency of an attenuation pole according to the second embodiment of the present invention;

FIG. 5(b) is a laminated sectional view of the unbalanced-balanced laminated band-pass filter for controlling the frequency of the attenuation pole according to the second embodiment of the present invention;

FIG. 6(a) is a diagram showing change in a frequency of the attenuation pole of the unbalanced-balanced laminated band-pass filter according to the second embodiment of the present invention;

FIG. 6(b) is a diagram showing a transition of a degree of balance (maximum amplitude difference) in the change in the frequency of the attenuation pole of the unbalanced-balanced laminated band-pass filter according to the second embodiment of the present invention;

FIG. 6(c) is a diagram showing a transition of a degree of balance (maximum phase difference) in the change in the frequency of the attenuation pole of the unbalanced-balanced laminated band-pass filter according to the second embodiment of the present invention;

FIG. 7 is an exploded perspective view of the unbalanced-balanced laminated band-pass filter for controlling the frequency of the attenuation pole according to the second embodiment of the present invention;

FIG. 8 is a first equivalent circuit diagram of the unbalanced-balanced laminated band-pass filter according to a third embodiment of the present invention;

FIG. 9 is an exploded perspective view of the unbalanced-balanced laminated band-pass filter according to the third embodiment of the present invention;

FIG. 10 is a second equivalent circuit diagram of the unbalanced-balanced laminated band-pass filter according to a fourth embodiment of the present invention;

FIG. 11 is an equivalent circuit diagram of the unbalanced-balanced laminated band-pass filter according to the fourth embodiment of the present invention;

FIG. 12 is a first equivalent circuit diagram of the unbalanced-balanced laminated band-pass filter according to a fifth embodiment of the present invention;

FIG. 13 is a first exploded perspective view of the unbalanced-balanced laminated band-pass filter according to the fifth embodiment of the present invention;

FIG. 14 is a second equivalent circuit diagram of the unbalanced-balanced laminated band-pass filter according to the fifth embodiment of the present invention;

FIG. 15 is a third equivalent circuit diagram of the unbalanced-balanced laminated band-pass filter according to the fifth embodiment of the present invention;

FIG. 16 is a block diagram showing that the unbalanced-balanced laminated band-pass filter and a semiconductor device can be directly connected according to a sixth embodiment of the present invention;

FIG. 17 is a perspective diagram wherein the semiconductor device is mounted on the unbalanced-balanced laminated filter according to the sixth embodiment of the present invention;

FIG. 18 is an equivalent circuit diagram of the conventional unbalanced laminated band-pass filter;

FIG. 19 is an exploded perspective view of the conventional unbalanced laminated band-pass filter;

FIG. 20 is an exploded perspective view wherein a loading capacity is used in a conventional laminated structure of the unbalanced laminated band-pass filter;

FIG. 21 is an exploded perspective view wherein SIR is used in the conventional laminated structure of the unbalanced laminated band-pass filter;

FIG. 22 is an equivalent circuit diagram of a conventional laminated balun;

FIG. 23 is an exploded perspective view of the conventional laminated balun;

FIG. 24 is a block diagram of the conventional unbalanced-balanced filter;

FIG. 25(a) is a diagram showing change in the frequency of the attenuation pole of the unbalanced-balanced laminated band-pass filter according to the second embodiment of the present invention;

FIG. 25(b) is a diagram showing the change in the frequency of the attenuation pole of the unbalanced-balanced laminated band-pass filter according to the second embodiment of the present invention;

FIG. 26 shows a block diagram of a radio communication device according to a seventh embodiment of the present invention;

FIG. 27 shows a block diagram of the radio communication device according to the seventh embodiment of the present invention;

FIG. 28 is a diagram showing a deformed example of the unbalanced-balanced laminated band-pass filter according to the first embodiment of the present invention;

FIG. 29 is a diagram showing a characteristic of the unbalanced-balanced laminated band-pass filter of the present invention shown in FIG. 28;

FIG. 30 is an exploded perspective view of the unbalanced-balanced laminated band-pass filter according to the sixth embodiment of the present invention; and

FIG. 31 is an exploded perspective view of the unbalanced-balanced laminated band-pass filter according to the sixth embodiment of the present invention.

### DESCRIPTION OF SYMBOLS

101a, 101b ½ wavelength stripline resonators
102, 103a, 103b Input-output coupling capacitances
104a, 104b Inter-section coupling capacitances
105 Unbalanced terminal
106a, 106b Balanced terminals
201a, 201b ½ wavelength stripline electrodes
202, 203a, 203b Input-output stripline electrodes
204a, 204b Inter-section stripline electrodes
205, 206a, 206b, 207a, 207b External conductor electrodes
208a, 208b Shield conductors
211, 212, 213, 214, 215 Dielectric layers
401a, 401b, 401c ½ wavelength stripline resonators
402, 403a, 403b Input-output coupling capacitances
404a, 404b, 404c, 404d Inter-section coupling capacitances
405 Unbalanced terminal
406a, 406b Balanced terminals
500 Centerline of a ½ wavelength stripline resonator
511a, 511b ½ wavelength stripline resonators
514a, 514b Inter-section coupling capacitance electrodes
701a, 701b, 701c, 701d ¼ wavelength stripline electrodes
702, 703a, 703b Input-output stripline electrodes
704a, 704b Inter-section stripline electrodes
705, 706a, 706b, 707a, 707b, 707c External conductors
708a, 708b, 708c Shield conductors
711, 712, 713, 714, 715, 716, 717, 718 Dielectric layers
801a ½ wavelength stripline resonator
821a, 821b ¼ wavelength stripline resonators
802, 803a, 803b Input-output coupling capacitances
804a, 804b Inter-section coupling capacitances
805 Unbalanced terminal
806a, 806b Balanced terminals
901a ½ wavelength stripline electrode
921a, 921b ¼ wavelength stripline electrodes
902, 903a, 903b Input-output stripline electrodes
904a, 904b Inter-section stripline electrodes
905, 906a, 906b, 907a, 907b External conductor electrodes
908a, 908b, 908c Shield conductors
909a, 909b Internal via conductors
911, 912, 913, 914, 915 Dielectric layers
1001a ½ wavelength stripline resonator
1021a, 1021b ¼ wavelength stripline resonators
1002, 1003a, 1003b Input-output coupling capacitances
1004a, 1004b Inter-section coupling capacitances
1005 Unbalanced terminal
1006a, 1006b Balanced terminals
1101a ½ wavelength stripline resonator
1121a, 1121b ¼ wavelength stripline resonators
1102, 1103a, 1103b Input-output coupling capacitances
1104a, 1104b Inter-section coupling capacitances
1105 Unbalanced terminal
1106a, 1106b Balanced terminals
1201b ½ wavelength stripline resonator
1231a ¼ wavelength stripline resonator
1202, 1203a, 1203b Input-output coupling capacitances
1204a Inter-section coupling capacitance
1205 Unbalanced terminal
1206a, 1206b Balanced terminals
1301a, 1301b, 1331a ¼ wavelength stripline electrodes
1302, 1303a, 1303b Input-output stripline electrodes
1304a Inter-section stripline electrode
1305, 1306a, 1306b, 1307a, 1307b, 1307c External conductor electrodes
1308a, 1308b, 1308c Shield conductors
1311, 1312, 1313, 1314, 1315, 1316, 1317, 1318 Dielectric layers
1401b ½ wavelength stripline resonator
1431a, 1431b ¼ wavelength stripline resonators
1402, 1403a, 1403b Input-output coupling capacitances
1404a, 1404b Inter-section coupling capacitances
1405 Unbalanced terminal
1406a, 1406b Balanced terminals
1501b, 1501c ½ wavelength stripline resonators
1531a ¼ wavelength stripline resonator
1502, 1503a, 1503b Input-output coupling capacitances
1504a, 1504b, 1504c Inter-section coupling capacitances
1505 Unbalanced terminal
1506a, 1506b Balanced terminals
160 Unbalanced-balanced band-pass filter
161 Semiconductor device
171 Unbalanced-balanced band-pass filter
172 Semiconductor device
181a, 181b ¼ wavelength stripline resonators
182a, 182b Input-output coupling capacitances
183 Inter-section coupling capacitance
184a, 184b Unbalanced terminals
191a, 191b ¼ wavelength stripline resonators
192a, 192b Input-output electrodes
193 Inter-section coupling electrodes
195a, 195b Shield conductors
1901, 1902, 1903, 1904, 1905, 1906 Dielectric layers
200a, 200b Loading capacity electrodes
217a, 217b, 218a, 218b Strip line resonators
2201 ½ wavelength stripline resonator
2202a, 2202b ¼ wavelength stripline resonators
2203 Unbalanced terminal
2204a, 2204b Balanced terminals
2301a ½ wavelength stripline electrode
2302a, 2302b ¼ wavelength stripline electrodes
2303, 2304a, 2304b Input-output electrodes
2308a, 2308b Shield conductors
2309a, 2309b Internal via conductors
2311, 2312, 2313, 2314, 2315 Dielectric layers
241 Unbalanced filter
242 Balanced-unbalanced converter (balun)
261, 262, 271, 272 Unbalanced-balanced band-pass filter
263, 273 Antennas
264, 274 Switches
265, 275 Transmitting amplifier
266, 276 Receiving amplifier
267, 277 RF-IC (Radio Frequency Integrated Circuit) semiconductor IC portion
268, 278 Baseband portions

### PREFERRED EMBODIMENTS OF THE INVENTION

Hereafter, embodiments of the present invention will be described by referring to the drawings.

### First Embodiment

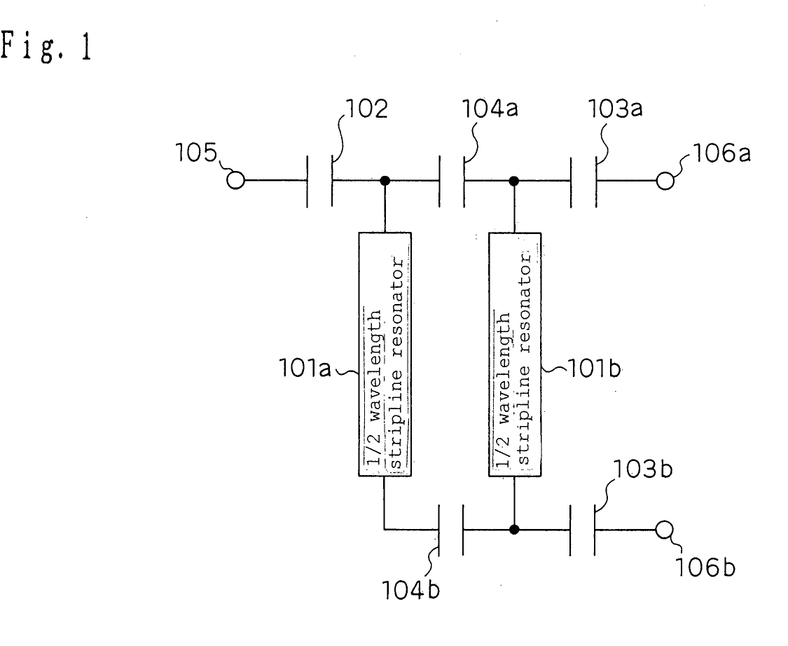

FIG. 1 is one of equivalent circuit diagrams of a band-pass filter of an unbalanced input (output)-balanced output (input) type according to a first embodiment of the present invention.

According to this configuration, stripline resonators 101a and 101b are electromagnetically coupled. The stripline resonators 101a and 101b substantially have the length of ½ wavelength (electrical length, same hereafter) of desired resonant frequencies. One end of the stripline resonator 101a is connected to an unbalanced input (output) terminal 105 via a coupling capacitance 102, and both ends of the stripline resonator 101b are connected to balanced output (input) terminals 106a and 106b via coupling capacitances 103a and 103b. Furthermore, two inter-section coupling capacitances 104a and 104b are connected between both ends of the stripline resonators 101a and 101b.

Next, operation of the band-pass filter shown in FIG. 1 will be described. The signal inputted from the unbalanced terminal 105 is conveyed to the stripline resonator 101a via the coupling capacitance 102. The stripline resonator 101a operates as an open circuit end ½ wavelength resonator, and the signal is conveyed to the second stripline resonator 101b via the inter-section coupling capacitances 104a and 104b and by electromagnetic coupling. In this case, as the two inter-section coupling capacitances 104a and 104b are placed around both ends of the stripline resonator 101a, outputs from the stripline resonator 101a become reversed-phase signals so as to be conveyed to the stripline resonator 101b. As the reversed-phase signals are inputted to both ends of the stripline resonator 101b, a middle point of the ½ wavelength stripline resonator 101b is virtually grounded, substantially operating as two ¼ wavelength short circuit end resonators. Furthermore, the signals conveyed to the stripline resonator 101b are conveyed as balanced signals to the balanced terminals 106a and 106b via the coupling capacitances 103a and 103b. Furthermore, the band-pass filter forms an attenuation pole as its pass characteristic because the stripline resonators 101a and 101b are connected by the inter-section coupling capacitances 104a and 104b.

As described above, the band-pass filter according to this embodiment plays a role of the balun for converting an unbalanced signal to a balanced signal by means of the stripline resonators 101a and 101b, and is further able to constitute the filter having the attenuation pole with the stripline resonators 101a, 101b and inter-section coupling capacitances 104a, 104b.

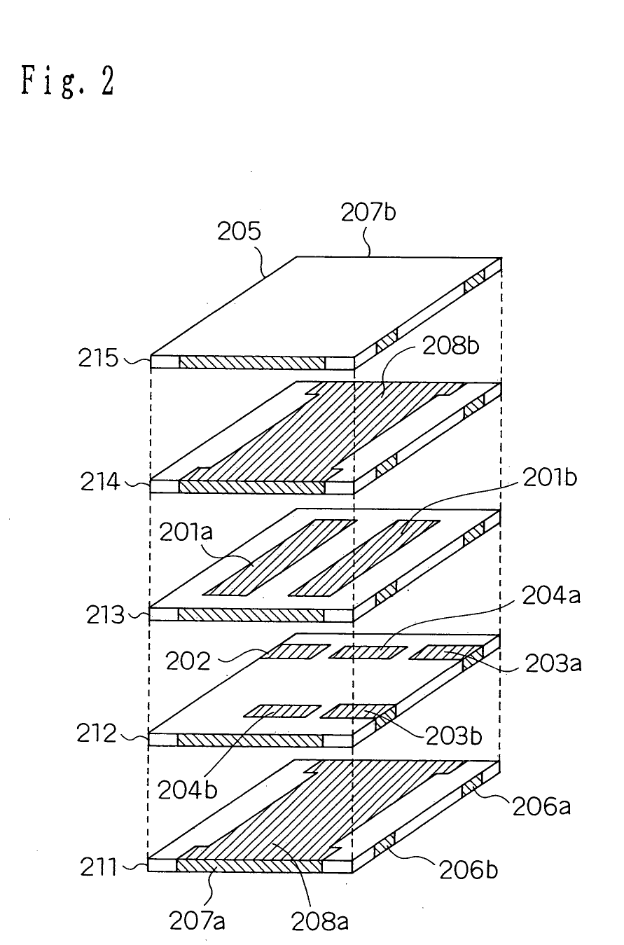

FIG. 2 is an exploded perspective view of a laminated structure of the band-pass filter of the unbalanced input (output)-balanced output (input) type for implementing the configuration of the equivalent circuit in FIG. 1. The laminated structure in FIG. 2 is constituted by using first to fifth dielectric layers 211, 212, 213, 214 and 215, first and second shield conductors 208a and 208b, stripline electrodes 201a and 201b, input-output stripline electrodes 202, 203a and 203b, inter-section stripline electrodes 204a and 204b, first to fifth external conductor electrodes 205, 206a, 206b, 207a and 207b. Each dielectric layer is comprised of a crystal of Bi—Ca—Nb—O system of relative permittivity εr=58.

The first shield conductor 208a is placed on a top surface of the first dielectric layer 211, and the second dielectric layer 212 is laminated on the first shield conductor 208a. The input-output stripline electrodes 202, 203a and 203b, inter-section stripline electrodes 204a and 204b are placed on the top surface of the second dielectric layer 212, and the third dielectric layer 213 is laminated thereon. The ½ wavelength stripline electrodes 201a and 201b are placed on the top surface of the third dielectric layer 213, and the fourth dielectric layer 214 is laminated thereon. The second shield conductor 208b is placed on the top surface of the fourth dielectric layer 214, and the fifth dielectric layer 215 is laminated thereon. The first to fifth external conductor electrodes 205, 206a, 206b, 207a and 207b are formed on four sides of each dielectric layer. These external conductor electrodes connect the electrodes connected to the dielectric layers. For instance, the first shield conductor 208a and the second shield conductor 208b are electrically connected via the external conductor electrodes 207a.

Next, a description will be given as to the operation of the band-pass filter according to the first embodiment of the present invention shown in FIG. 2. The ½ wavelength stripline electrodes 201a and 201b in FIG. 2 are electromagnetically coupled via the third dielectric layer 213, and operate as the ½0 wavelength stripline resonators 101a and 101b in FIG. 1 respectively. One end of the input-output stripline electrode 202 forms the unbalanced input (output) terminal 105 by connecting to the first external conductor electrode 205. The other end of the input-output stripline electrode 202 forms parallel plate capacitors sandwiching the third dielectric layer 213 together with an opposed portion (corresponding to one end of the first stripline resonator of the present invention) to the ½ wavelength stripline electrode 201a so as to form the coupling capacitance 102. Ends of the input-output stripline electrodes 203a and 203b form the balanced output (input) terminals 106a and 106b by connecting to the second and third external conductor electrode 206a and 206b. The other ends of the input-output stripline electrodes 203a and 203b form the parallel plate capacitors sandwiching the third dielectric layer 213 together with the opposed portion (corresponding to both ends of the second stripline resonator of the present invention) to the ½ wavelength stripline electrode 201b so as to form the coupling capacitances 103a and 103b. The inter-section stripline electrodes 204a and 204b form the parallel plate capacitors together with the respective opposed portions to the ½ wavelength stripline electrodes 201a and 201b so as to form the inter-section coupling capacitances 104a and 104b between the resonators. Thus, the laminated structure in FIG. 2 is the configuration for implementing the equivalent circuit in FIG. 1.

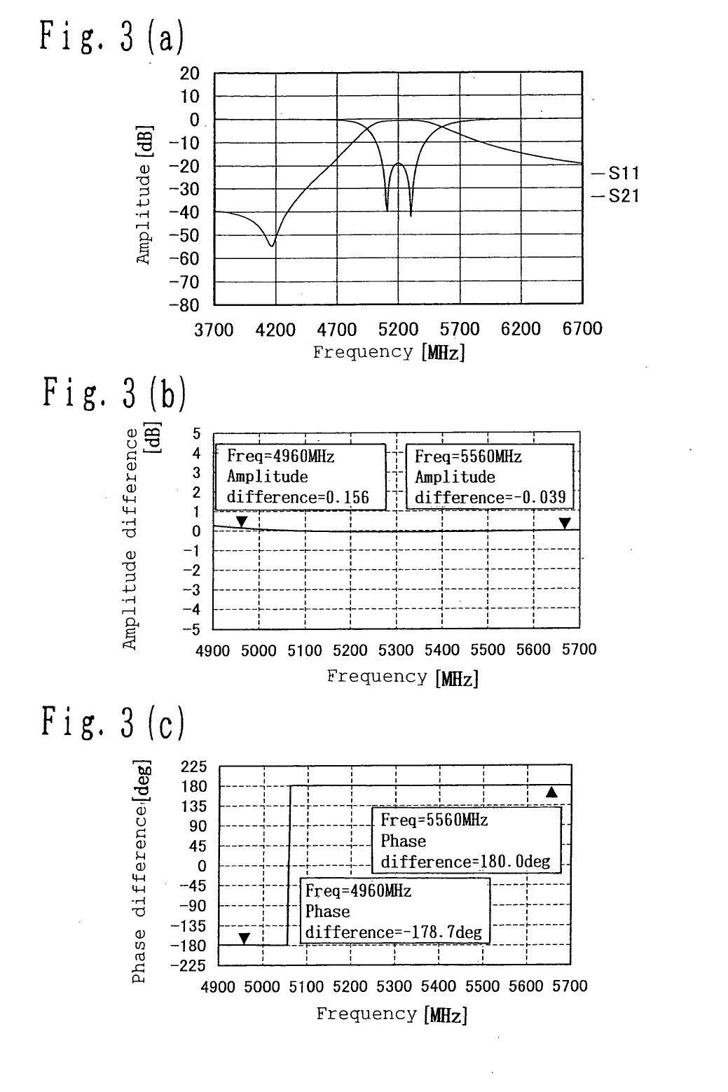

FIG. 3(a) shows a transmission characteristic of an unbalanced input-balanced output band-pass filter of the equivalent circuit in FIG. 1. FIG. 3(b) and (c) show balance characteristics in that pass band. The balance characteristic represents an amplitude difference and a phase difference of a balanced output signal. In FIG. 3(a), however, the horizontal axis indicates a frequency (MHz) and the vertical axis indicates an amplitude (dB) by which the signals outputted from the balanced terminal are synthesized. In FIG. 3(b), the horizontal axis indicates the frequency (MHz) and the vertical axis indicates an amplitude difference (dB) of the signals outputted from the balanced terminal in the pass band. In FIG. 3(c), the horizontal axis indicates the frequency (MHz) and the vertical axis indicates a phase difference (degrees) of the signals outputted from the balanced terminal in the pass band. The transmission characteristic of an unbalanced input-balanced output band-pass filter in the equivalent circuit in FIG. 1 is the characteristic for generating the attenuation pole on a low-pass side of a desired band according to FIG. 3(a), and is the characteristic close to an ideal balance characteristic (amplitude difference of 0 dB, phase difference of ±180 degrees) according to FIG. 3(b).

If an input signal is added from the unbalanced terminal 105, the signals substantially of the amplitude difference 0 dB and phase difference 180 degrees are outputted from the balanced terminals 106a and 106b in a desired band. If the reversed-phase signals substantially of the amplitude difference 0 dB are added to the balanced terminals 106a and 106b, a synthetic signal thereof is outputted from the unbalanced terminal 105. As the transmission characteristic thereof has the attenuation pole, the filter of the present invention can sufficiently prevent noise outside the desired band. It can implement further miniaturization compared to the configuration in the past.

As for the characteristic of the equivalent circuit in FIG. 1, the number of components is smaller than the configuration for externally connecting an unbalanced laminated band-pass filter to a laminated balun in the past so that the loss in the pass band is improved by 50 percent or so.

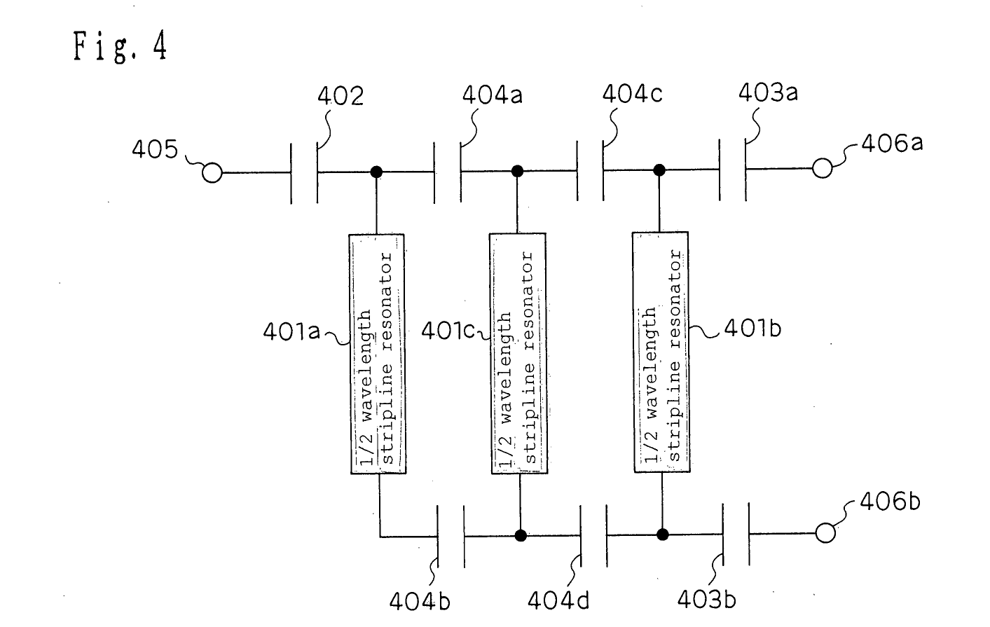

The first embodiment of the present invention was described as having two stripline resonators, there may be three or more. For instance, as shown in FIG. 4, it may be the configuration wherein three ½ wavelength stripline resonators 401a, 401b and 401c are coupled by inter-section coupling capacitances 404a, 404b, 404c and 404d respectively. The operation of this circuit is the same as that of the equivalent circuit in FIG. 1 so that the unbalanced-balanced band-pass filter also having the attenuation pole is constituted.

The first embodiment of the present invention can be further miniaturized by rendering the resonators shorter by means of a loading capacity and SIR.

The configuration described above has the characteristic close to an ideal balance characteristic, and the transmission characteristic thereof has a band-pass filter characteristic having the attenuation pole. In the case of the laminated structure as described, the number of components is significantly smaller than the configuration in the past. Therefore, it is possible to realize the miniaturization as the configuration of the unbalanced-balanced laminated filter and significantly improve the loss in the pass band as to the transmission characteristic.

### Second Embodiment

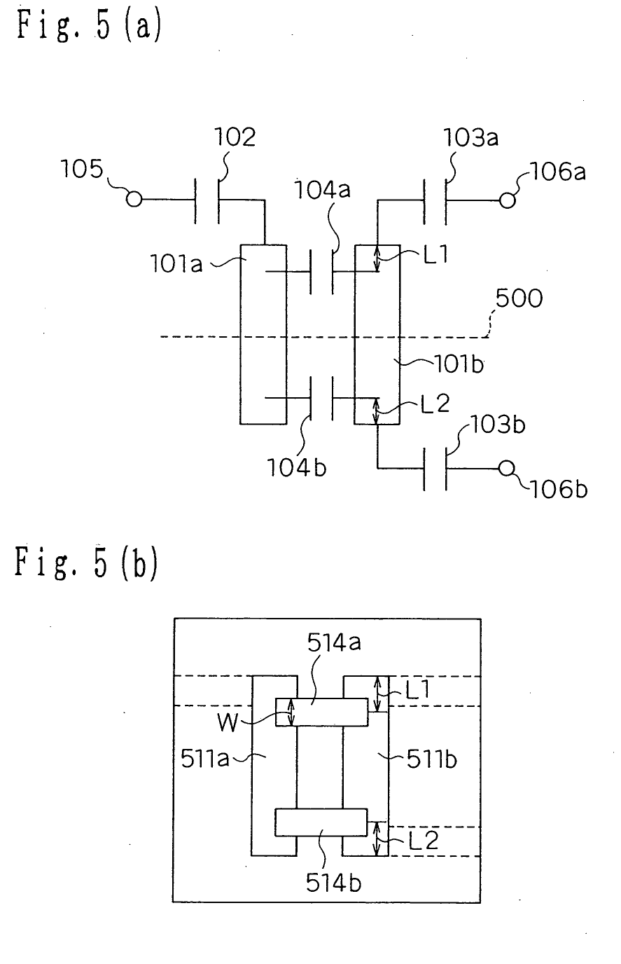

Next, FIG. 5(a) shows an equivalent circuit configuration of the band-pass filter of the unbalanced input (output)-balanced output (input) type for controlling the frequency of the attenuation pole according to the second embodiment of the present invention.

As shown in FIG. 5(a), this is the configuration wherein, as to the equivalent circuit configuration of the unbalanced-balanced laminated filter in FIG. 1, the inter-section coupling capacitance 104a as an example of a first capacity element of the present invention and the inter-section coupling capacitance 104b as an example of a second capacity element are placed at distances L1 and L2 in a central direction from both ends of the pair of stripline resonators 101a and 101b of substantial ½ wavelength of the resonant frequencies respectively. It is possible to realize the laminated structure for implementing this equivalent circuit by changing coupling positions of the inter-section coupling capacitances in FIG. 2 of the first embodiment. A concrete positional relationship thereof is shown in FIG. 5(b). Here, the above L1 and L2 are defined as the distances between both ends of each of stripline resonators 511a and 511b and centers of the widths of inter-section coupling capacitance electrodes 514a and 514b. Accordingly, it is possible to change the distances L1 and L2 by 0.5 W or more which is a half of a width W of the inter-section coupling capacitance electrode. To be more specific, in the case where the inter-section coupling capacitance electrodes 514a and 514b are placed at both ends of the stripline resonators 511a and 511b, it is L1=½ W and L2=½ W so that L1 and L2 are the minimum values.

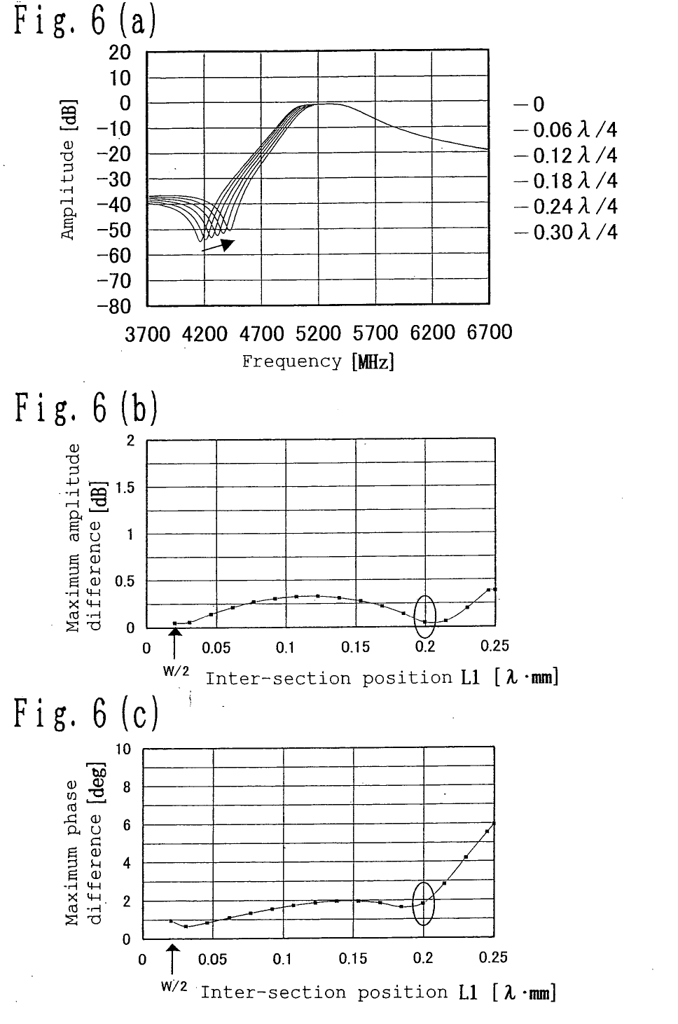

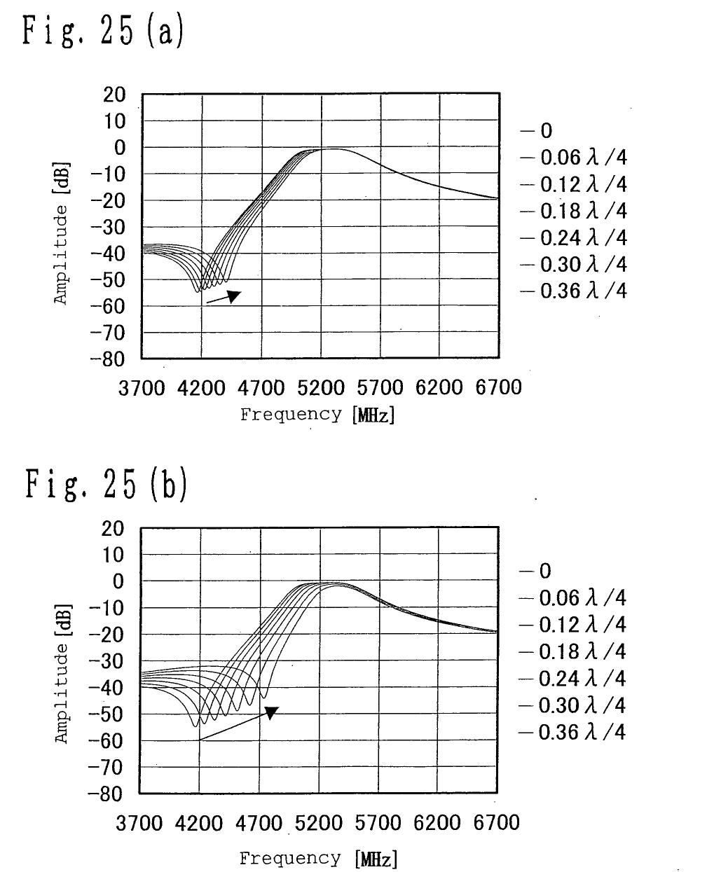

FIGS. 6(a) to (c) show the characteristics in the case of changing the positions of one or two inter-section coupling capacitances in the above range. FIGS. 6(a) to (c) show the change in the transmission characteristic and the balance characteristic in the pass band in the case of moving the inter-section coupling capacitance electrode 514a on the side to which the unbalanced terminal 105 is connected of the two inter-section coupling capacitances, that is, in the case of changing L1. FIG. 25(a) shows the change in the transmission characteristic in the case of moving the other inter-section coupling capacitance electrode 514b, that is, in the case of changing L2. FIG. 25(b) shows the change in the transmission characteristic in the case of moving each of the two inter-section coupling capacitance electrodes 514a and 514b by the same distance from both ends of the stripline resonator, that is, in the case of changing L1 and L2 to the same extent. As for the horizontal axes, FIGS. 6(a) and FIGS. 25(a) and (b) indicate the frequencies, and FIGS. 6(b) and (c) indicate the position (L1) of the inter-section coupling capacitance electrode. As for the vertical axes, FIGS. 6(a) and FIGS. 25(a) and (b) indicate the amplitude (dB) having the signals outputted from the balanced terminals mutually synthesized, FIGS. 6(b) indicates the maximum amplitude difference (dB) in the band of the signals outputted from the balanced terminals, and FIGS. 6(c) indicates the maximum phase difference in the band. Consequently, it can be seen from FIGS. 6(a) and FIGS. 25(a) and (b) that the frequency of the attenuation pole is changed to the higher side by moving either position of the two inter-section coupling capacitances toward the center of the ½ wavelength stripline resonators 511a and 511b. As shown in FIGS. 6(b) and (c), as for the balance characteristic, it is desirable to change L1 in the range of 0.2λ (λ is a wavelength at the resonant frequency) or less because, in the case of changing only L1, the maximum amplitude difference and maximum phase difference are abruptly deteriorated at 0.2λ (wavelength) or more.

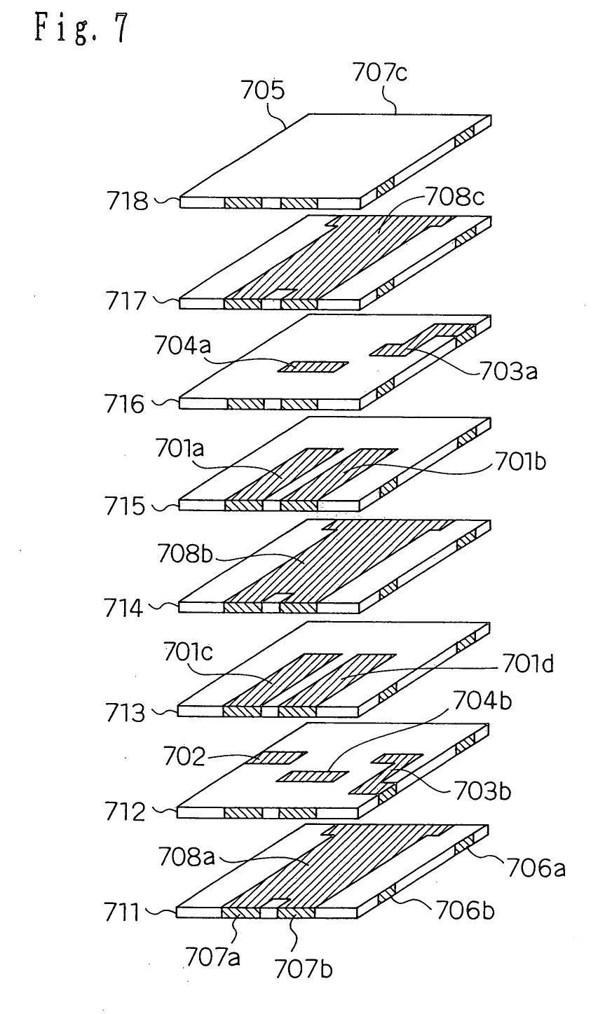

Next, FIG. 7 is an exploded perspective view of the laminated structure for implementing the equivalent circuit configuration for controlling the frequency of the attenuation pole in FIG. 5(a). The configuration and operation of the filter according to this embodiment will be described by referring to FIG. 7. The laminated structure in FIG. 7 is constituted by using first to eighth dielectric layers 711, 712, 713, 714, 715, 716, 717 and 718, first to third shield conductors 708a, 708b and 708c, stripline electrodes 701a, 701b, 701c, 701d, 702, 703a, 703b, 704a and 704b, and first to sixth external conductors 705, 706a, 706b, 707a, 707b and 707c.

The shield conductor 708a is placed on a top surface of the first dielectric layer 711, and the second dielectric layer 712 is laminated on the shield conductor 708a, and the stripline electrodes 702, 703b and 704b are placed on the top surface thereof. The third dielectric layer 713 is further laminated thereon, the stripline electrodes 701c and 701d are placed on the top surface thereof, the fourth dielectric layer 714 is laminated thereon, the shield conductor 708b is placed on the top surface thereof, the fifth dielectric layer 715 is laminated thereon, and the stripline electrodes 701a and 701b are placed on the top surface thereof. Furthermore, the sixth dielectric layer 716 is laminated thereon, the stripline electrodes 703a and 704a are placed on the top surface thereof, the seventh dielectric layer 717 is laminated thereon, the shield conductor 708c is placed on the top surface thereof, and the eighth dielectric layer 718 is laminated thereon. The external conductors 705, 706a, 706b, 707a, 707b and 707c are formed on the four sides of the layered product thus laminated.

The stripline electrodes 701a and 701b in FIG. 7 are electromagnetically coupled via the fifth dielectric layer 715, and the stripline electrodes 701c and 701d are electromagnetically coupled via the third dielectric layer 713. Here, the stripline electrodes 701a, 701b, 701c and 701d are substantially constituted as the stripline resonators of ¼ wavelength of desired resonant frequencies. The stripline electrodes 701a and 701c, and the stripline electrodes 701b and 701d are having the shield conductor 708b in between them respectively. The stripline electrodes 701a and 701c are connected by the external conductor 707a, and the stripline electrodes 701b and 701d are connected by the external conductor 707b. Thus, the stripline electrodes 701a and 701c combinedly form the ½ wavelength stripline resonator 101a, and the stripline electrodes 701b and 701d combinedly form the ½ wavelength stripline resonator 101b.

One end of the stripline electrode 702 is connected to the external conductor 705 to form the unbalanced input (output) terminal 105, and forms the parallel plate capacitors sandwiching the third dielectric layer 713 together with the opposed portion (corresponding to one end of the first stripline resonator of the present invention) to the stripline electrode 701c so as to form the coupling capacitances 102. One end of the stripline electrode 703a is connected to the external conductor 706a to form one of the balanced output (input) terminals 106a, and forms the parallel plate capacitors sandwiching the sixth dielectric layer 716 together with the opposed portion (corresponding to either end of the second stripline resonator of the present invention) to the stripline electrode 701b so as to form the coupling capacitances 103a. One end of the stripline electrode 703b is connected to the external conductor 706b to form the balanced output (input) terminal 106b, and forms the parallel plate capacitors sandwiching the third dielectric layer 713 together with the opposed portion (corresponding to the other end of the second stripline resonator of the present invention) to the stripline electrode 701d so as to form the coupling capacitances 103b. The stripline electrode 704a is placed opposite the stripline electrodes 701a and 701b to form the inter-section coupling capacitance 104a between the resonators, and the stripline electrode 704b is placed opposite the stripline electrodes 701c and 701d to form the inter-section coupling capacitance 104b between the resonators.

It is possible, by controlling at least one of the positions of the stripline electrodes 704a and 704b, to control the frequency of the attenuation pole as mentioned above. In this case, the stripline electrodes 704a and 704b are placed in different dielectric layers, and the shield conductor 708b is in between them so as to have the effect of counteracting the mutual coupling.

According to this configuration, the stripline electrodes 701a and 701c, and the stripline electrode 701b and the fourth stripline electrode 701d are connected by the external conductors 707a and 707b respectively to form the ½ wavelength stripline resonators 101a and 101b. However, they may also be connected by using the internal via conductors. The above configuration can realize further miniaturization than the case of the first embodiment.

According to the second embodiment of the present invention, it is possible, even if constituted by further adding the stripline resonators of substantial ½ wavelength, to realize the unbalanced-balanced band-pass filter.

According to the second embodiment of the present invention, it can be further miniaturized by rendering the stripline resonators shorter by means of the loading capacity and SIR.

As described above, as with the configuration according to the first embodiment, the configuration according to the second embodiment of the present invention has the characteristic close to the ideal balance characteristic, and its transmission characteristic has the band-pass filter characteristic having the attenuation pole. The described laminated structure has the number of components significantly smaller than the configuration in the past, and so it can realize the miniaturization as the configuration of the unbalanced-balanced laminated filter and significantly improve the loss in the pass band as to the transmission characteristic.

### Third Embodiment

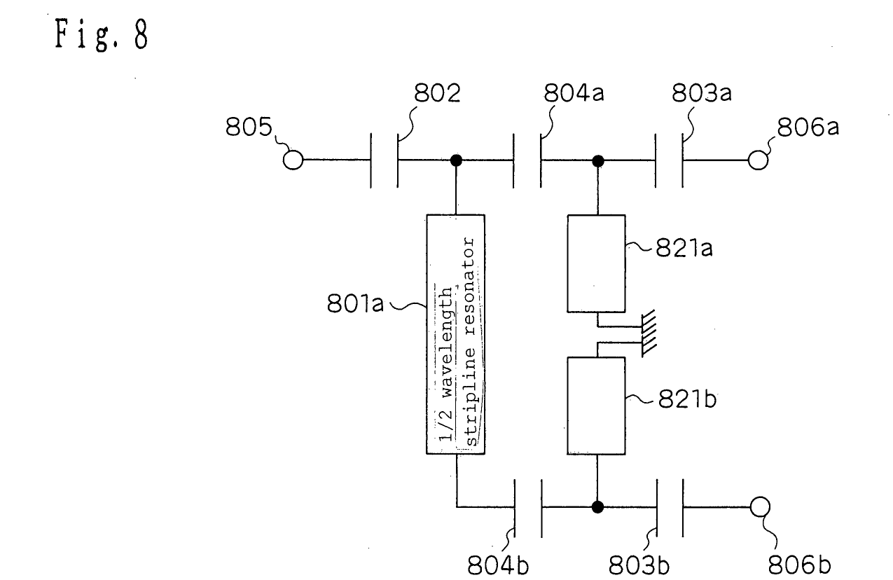

FIG. 8 is an equivalent circuit diagram of the unbalanced-balanced band-pass filter according to a third embodiment of the present invention.

According to this configuration, there are one stripline resonator 801a of substantial ½ wavelength of the desired resonant frequencies and a pair of stripline resonators 821a and 821b of substantial ¼ wavelength of the desired resonant frequencies. The stripline resonators 821a and 821b are placed in parallel with the stripline resonator 801a and mutually in series in order to be electromagnetically coupled respectively. One end of the stripline resonator 801a is connected to an unbalanced input (output) terminal 805 via a coupling capacitance 802. Ends of the respective stripline resonators 821a and 821b are connected to balanced output (input) terminals 806a and 806b via coupling capacitances 803a and 803b, and the other ends of the respective stripline resonators 821a and 821b form the short circuit ends. Furthermore, an inter-section coupling capacitance 804a is connected between the stripline resonators 801a and 821a, and an inter-section coupling capacitance 804b is connected between the stripline resonators 801a and 821b.

Next, the operation of the band-pass filter shown in FIG. 8 will be described. The signal inputted from the unbalanced terminal 805 is conveyed to the stripline resonator 801a via the coupling capacitance 802. The stripline resonator 801a operates as the open circuit end ½ wavelength resonator, and the signal is conveyed to the stripline resonators 821a and 821b via the inter-section coupling capacitances 804a and 804b. In this case, as the inter-section coupling capacitances 804a and 804b are placed around both ends of the stripline resonator 801a, the outputs from the stripline resonator 801a become the reversed-phase signals so as to be conveyed to the stripline resonators 821a and 821b. The stripline resonators 821a and 821b operate as the ¼ wavelength short circuit end resonators. Furthermore, the stripline resonators 821a and 821b convey the conveyed signals as the balanced signals to the balanced terminals 806a and 806b via the coupling capacitances 803a and 803b. Furthermore, the band-pass filter forms the attenuation pole as its pass characteristic because the stripline resonators 801a and 821b are connected by the inter-section coupling capacitance 804a and the stripline resonators 801a and 821b are connected by the inter-section coupling capacitance 804b.

As described above, the stripline resonators 801a, 821a and 821b constitute the balun for converting the unbalanced signal to the balanced signal, and further operate as the filter having the attenuation pole together with inter-section coupling capacitances 804a and 804b.

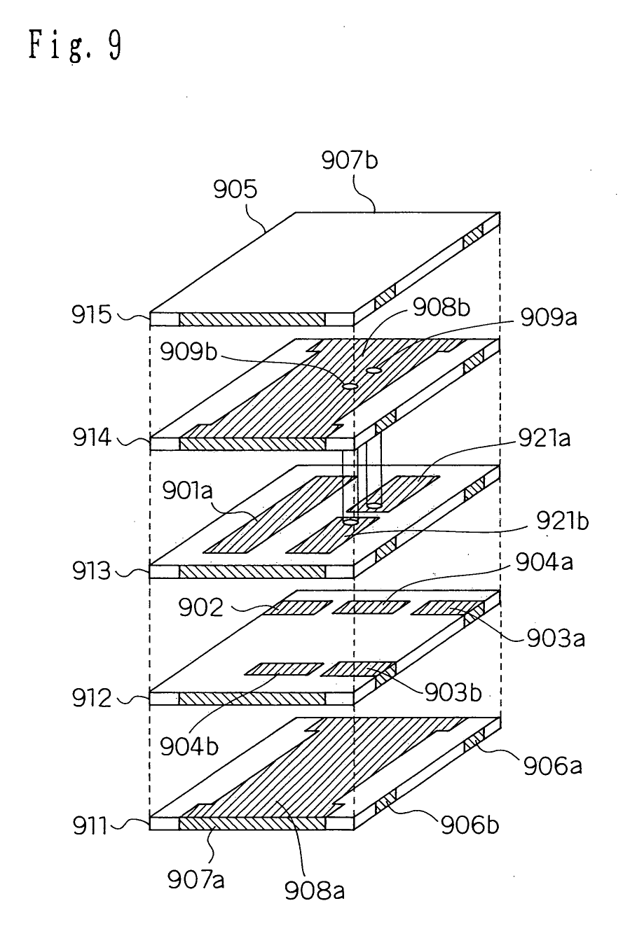

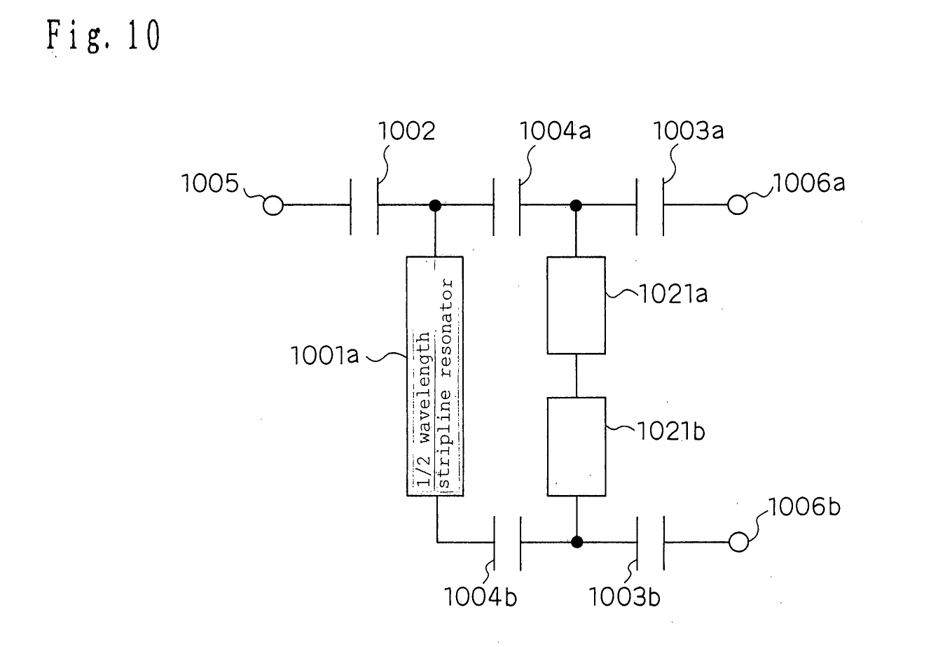

FIG. 9 is an exploded perspective view of the laminated structure of the band-pass filter of the unbalanced input (output)-balanced output (input) type for implementing the configuration of the equivalent circuit in FIG. 8. The laminated structure in FIG. 9 is constituted by using first to fifth dielectric layers 911, 912, 913, 914 and 915, first and second shield conductors 908a and 908b, stripline electrodes 901a, 902, 903a, 903b, 904a, 904b, 921a and 921b, first to fifth external conductors 905, 906a, 906b, 907a and 907b, and first and second internal via conductors 909a and 909b. Each dielectric layer is comprised of the crystal of Bi—Ca—Nb—O system of relative permittivity (εr)=58.

The first shield conductor 908a is placed on the top surface of the first dielectric layer 911, and the second dielectric layer 912 is laminated on the first shield conductor 908a. The stripline electrodes 902, 903a, 903b, 904a and 904b are placed on the top surface thereof, and the third dielectric layer 913 is laminated thereon. Furthermore, the stripline electrodes 901a, 921a and 921b are placed on the top surface of the third dielectric layer 913, and the fourth dielectric layer 914 is laminated thereon, the second shield conductor 908b is placed on the top surface thereof, and the fifth dielectric layer 915 is laminated thereon. The first to fifth external conductors 905, 906a, 906b, 907a and 907b are formed on the four sides of the layered product thus constituted, and the internal via conductors 909a and 909b are formed in the fourth dielectric layer 914.

Next, a description will be given as to the operation of the laminated structure in FIG. 9 according to a third embodiment of the present invention. The stripline electrodes 901a and 921a and the stripline electrodes 901a and 921b in FIG. 9 are electromagnetically coupled via the third dielectric layer 913. Ends of the stripline electrodes 921a and 921b are connected to the shield conductor 908b via the internal via conductors 909a and 909b so as to operate as the short circuit ends. One end of the stripline electrode 902 is connected to the external conductor 905 to form the unbalanced input (output) terminal 805, and the other end thereof forms the parallel plate capacitors sandwiching the third dielectric layer 913 together with the opposed portion to the stripline electrode 901a so as to form the coupling capacitance 802. Ends of the stripline electrodes 903a and 903b are connected to the external conductors 906a and 906b to form the balanced output (input) terminals 806a and 806b respectively, and the other ends thereof form the parallel plate capacitors sandwiching the third dielectric layer 913 together with the opposed portion to the stripline electrodes 921a and 921b so as to form the coupling capacitances 803a and 803b. The stripline electrodes 904a and 904b form the parallel plate capacitors together with the opposed portion to the stripline electrodes 901a, 921a and 921b so as to form the inter-section coupling capacitances 804a and 804b between the resonators.

According to the third embodiment of the present invention, it is possible, even if constituted by further adding the stripline resonators of ½ wavelength in substance, to realize the unbalanced-balanced band-pass filter.

According to the third embodiment of the present invention, it can be further miniaturized by rendering the stripline resonators shorter by means of the loading capacity and SIR.

According to the third embodiment, it is possible, by changing the coupling positions of the two inter-section coupling capacitances, to have the same effect of controlling the frequency of the attenuation pole as described as to the second embodiment.

As described above, as with the configurations according to the first or second embodiment of the present invention, the configuration according to the third embodiment has the characteristic close to the ideal balance characteristic, and its transmission characteristic has the band-pass filter characteristic having the attenuation pole. The described laminated structure has the number of components significantly smaller than the configuration in the past, and so it can realize the miniaturization as the configuration of the unbalanced-balanced laminated filter and significantly improve the loss in the pass band as to the transmission characteristic.

### Fourth Embodiment

Next, FIG. 10 is an equivalent circuit diagram of the unbalanced-balanced band-pass filter according to a fourth embodiment of the present invention.

According to this configuration, there are one stripline resonator 1001a of substantial ½ wavelength of the desired resonant frequencies and a pair of stripline resonators 1021a and 1021b of substantial ¼ wavelength of the desired resonant frequencies. The stripline resonators 1021a and 1021b are placed in parallel with the stripline resonator 801a so as to be electromagnetically coupled respectively. One end of the stripline resonator 1001a is connected to an unbalanced input (output) terminal 1005 via a coupling capacitance 1002. Ends of the stripline resonators 1021a and 1021b are connected to balanced output (input) terminals 1006a and 1006b via coupling capacitances 1003a and 1003b. The stripline resonators 1021a and 1021b are mutually connected in series. Furthermore, an inter-section coupling capacitance 1004a is connected between one of the open ends of the stripline resonators 1001a and the open end of the stripline resonators 1021a, and an inter-section coupling capacitance 1004b is connected between the other end of the open end of the stripline resonators 1001a and that of the stripline resonators 1021b.

This is the configuration wherein the equivalent circuit configuration according to the first embodiment is constituted by two series-connected ¼ wavelength stripline resonators 1021a and 1021b in place of the ½ wavelength stripline resonators 101b. Therefore the operation in the configuration in FIG. 10 is the same as the operation in the equivalent circuit configuration according to the first embodiment.

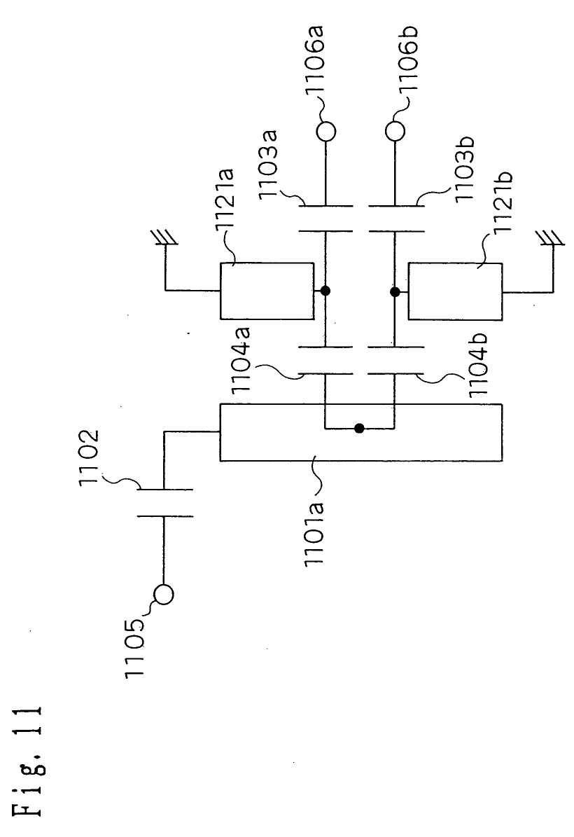

Furthermore, FIG. 11 is another equivalent circuit diagram representing the unbalanced-balanced band-pass filter according to the fourth embodiment of the present invention.

According to this configuration, one ½ wavelength stripline resonator 1101a and a pair of ¼ wavelength stripline resonators 1121a and 1121b are placed in parallel to be electromagnetically coupled respectively. One end of the stripline resonator 1101a is connected to an unbalanced input (output) terminal 1105 via a coupling capacitance 1102. Ends of the stripline resonators 1121a and 1121b are connected to balanced output (input) terminals 1106a and 1106b via coupling capacitances 1103a and 1103b respectively, and the other ends of the stripline resonators 1121a and 1121b form the short circuit ends respectively. Furthermore, an inter-section coupling capacitance 1104a is connected between the center of the stripline resonator 1101a and the open end of the stripline resonator 1121a, and 1104b is connected between the center of the stripline resonator 1101a and the open end of the stripline resonator 1121b.

This configuration is equivalent to the equivalent circuit configuration in FIG. 8 according to the third embodiment wherein the point at which the two inter-section coupling capacitances 804a and 804b are connected is changed from both ends to the center of the ½ wavelength stripline resonator 801a, and it performs the same operation. Therefore, it is also possible, according to this configuration, to constitute the filter having the attenuation pole.

According to the fourth embodiment of the present invention, it is possible, even if constituted by further adding the stripline resonators of ½ wavelength in substance, to realize the unbalanced-balanced band-pass filter.

According to the fourth embodiment of the present invention, it can be further miniaturized by rendering the stripline resonators shorter by means of the loading capacity and SIR.

According to the fourth embodiment, it is possible, by changing the coupling positions of the two inter-section coupling capacitances, to have the same effect of controlling the frequency of the attenuation pole as described as to the second embodiment.

As described above, as with the configurations according to the first, second or third embodiment of the present invention, the configuration according to the fourth embodiment has the characteristic close to the ideal balance characteristic, and its transmission characteristic has the band-pass filter characteristic having the attenuation pole. The laminated structure of the described configuration has the number of components significantly smaller than the configuration in the past, and so it can realize the miniaturization as the configuration of the unbalanced-balanced laminated filter and significantly improve the loss in the pass band as to the transmission characteristic.

### Fifth Embodiment

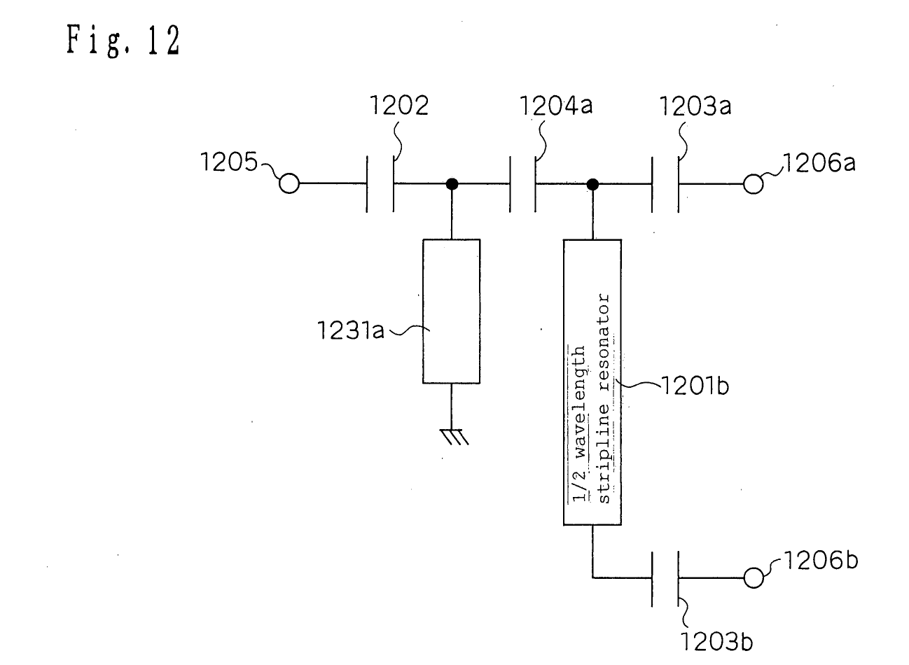

Next, FIG. 12 is an equivalent circuit diagram of the unbalanced-balanced band-pass filter according to a fifth embodiment of the present invention.

According to this configuration, there are one stripline resonator 1231a of substantial ¼ wavelength of the desired resonant frequencies and one stripline resonator 1201b of substantial ½ wavelength of the desired resonant frequencies placed in parallel to be electromagnetically coupled respectively. One end of the stripline resonator 1231a is connected to an unbalanced input (output) terminal 1205 via a coupling capacitance 1202, and the other end thereof forms the short circuit end. Both ends of the stripline resonator 1201b are connected to balanced output (input) terminals 1206a and 1206b via coupling capacitances 1203a and 1203b respectively. Furthermore, an inter-section coupling capacitance 1204a is connected between the open end of the stripline resonator 1231a and one end of the stripline resonators 1201b.

Next, a description will be given as to the operation of the band-pass filter shown in FIG. 12. The signal inputted from the unbalanced terminal 1205 is conveyed to the stripline resonator 1231a via the coupling capacitance 1202. The stripline resonator 1231a operates as the short circuit end ¼ wavelength resonator, and the signal is conveyed to the stripline resonator 1201b via the inter-section coupling capacitance 1204a. The stripline resonator 1201b operates as the open circuit end ½ wavelength resonator, and also operates as the filter having the attenuation pole together with the stripline resonator 1231a and the inter-section coupling capacitance 1204a. As the stripline resonator 1201b is the ½ wavelength resonator, the signal conveyed to the stripline resonator 1201b is outputted as the balanced signal to the balanced terminals 1206a and 1206b.

This configuration can realize the unbalanced-balanced band-pass filter.

According to the configuration in FIG. 12, it is possible to realize the same unbalanced-balanced band-pass filter by constituting one ¼ wavelength stripline resonator with two ¼ wavelength stripline resonators via the inter-section coupling capacitance.

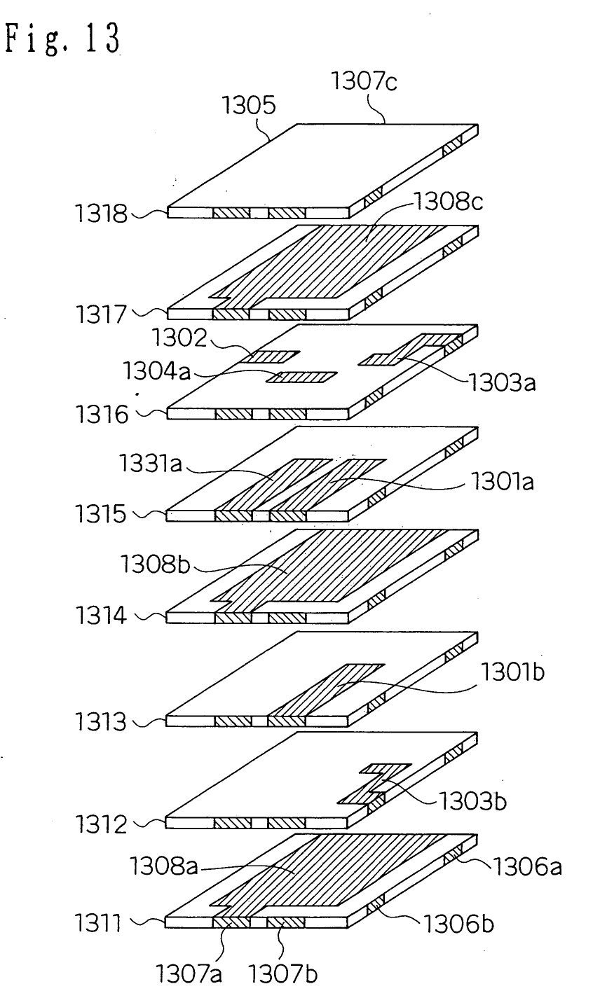

FIG. 13 is an exploded perspective view of the laminated structure for implementing the equivalent circuit configuration in FIG. 12. The laminated structure in FIG. 13 is constituted by using first to eighth dielectric layers 1311, 1312, 1313, 1314, 1315, 1316, 1317 and 1318, first to third shield conductors 1308a, 1308b and 1308c, stripline electrodes 1331a, 1301a, 1301b, 1302, 1303a, 1303b and 1304a, first to sixth external conductor electrodes 1305, 1306a, 1306b, 1307a, 1307b and 1307c.

The shield conductor 1308a is placed on the top surface of the first dielectric layer 1311, and the second dielectric layer 1312 is laminated thereon, the stripline electrode 1303b is placed on the top surface thereof. Furthermore, the third dielectric layer 1313 is laminated thereon, the stripline electrodes 1301b is placed on the top surface thereof, the fourth dielectric layer 1314 is laminated thereon, the shield conductor 1308b is placed on the top surface thereof, the fifth dielectric layer 1315 is laminated thereon, and the stripline electrodes 1331a and 1301a are placed on the top surface thereof. Furthermore, the sixth dielectric layer 1316 is laminated thereon, the stripline electrodes 1302, 1303a and 1304a are placed on the top surface thereof, the seventh dielectric layer 1317 is laminated thereon, the shield conductor 1308c is placed on the top surface thereof, and the eighth dielectric layer 1318 is laminated thereon. The external conductors 1305, 1306a, 1306b, 1307a, 1307b and 1307c are formed on the four sides of the layered product thus constituted.

Next, a description will be given as to the operation of the laminated structure in FIG. 13 according to a fifth embodiment. The stripline electrodes 1331a and 1301a in FIG. 13 are electromagnetically coupled via the fifth dielectric layer 1315. Here, the stripline electrodes 1331a, 1301a and 1301b are constituted as the ¼ wavelength stripline resonators respectively. The stripline electrodes 1301a and 1301b are connected to the external conductor 1307b by sandwiching the shield conductor 1308b so as to combinedly form a ½ wavelength stripline resonator 1201b. One end of the stripline electrode 1302 is connected to the external conductor 1305 to form an unbalanced terminal 1205, and the other end thereof forms the parallel plate capacitors sandwiching the sixth dielectric layer 1316 together with the opposed portion to the stripline electrode 1331a so as to form the coupling capacitance 1202. One end of the stripline electrode 1303a is connected to the external conductor 1306a to form one of the balanced terminals 1206a, and the other end thereof forms the parallel plate capacitors sandwiching the sixth dielectric layer 1316 together with the opposed portion to the stripline electrode 1301a so as to form the coupling capacitance 1203a. One end of the stripline electrode 1303b is connected to the external conductor 1306b to form the other balanced terminal 1206b, and the other end thereof forms the parallel plate capacitors sandwiching the third dielectric layer 1313 together with the opposed portion to the stripline electrode 1301b so as to form the coupling capacitance 1203b. The stripline electrode 1304a forms the parallel plate capacitors together with the opposed portions to the stripline electrodes 1331a and 1301a so as to form the inter-section coupling capacitance 1204a between the resonators.

According to this configuration, the stripline electrodes 1301a and 1301b are connected by the external conductor 1307b so as to form a ½ wavelength stripline resonator 1201b. It is also possible to connect the stripline electrodes 1301a and 1301b by using the internal via conductor. The mutual coupling is counteracted by having the shield conductor 1308b between the stripline electrodes 1301a and 1301b. It is possible to implement further miniaturization by this configuration.

It can be further miniaturized by rendering the stripline resonators shorter by means of the loading capacitor and SIR.

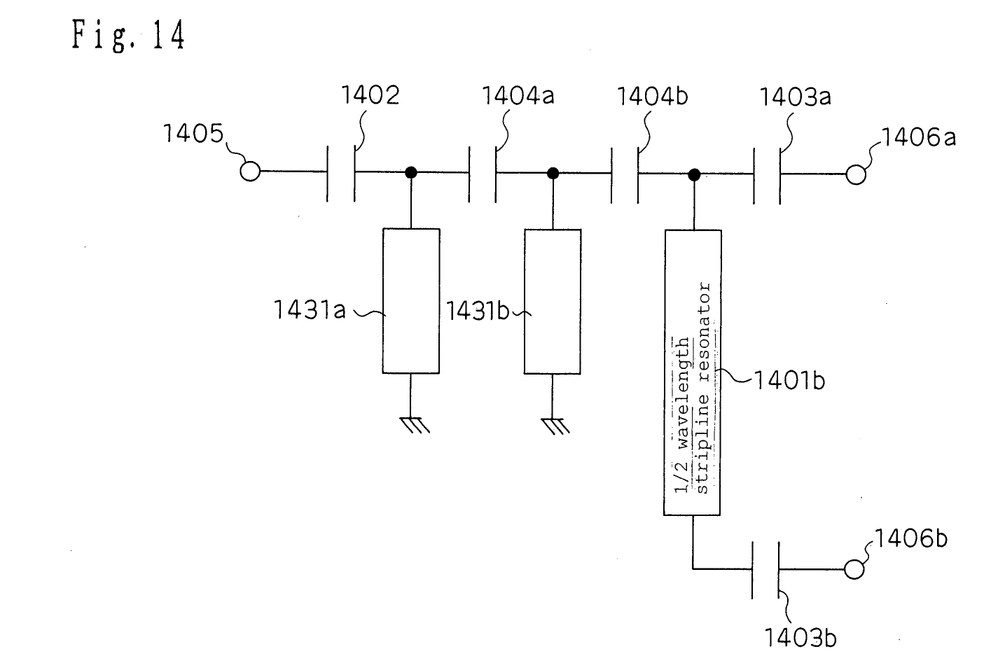

FIG. 14 is an equivalent circuit diagram comprised of two ¼ wavelength stripline resonators 1431a, 1431b and one ½ wavelength stripline resonator 1401b.

According to this configuration, there are two ¼ wavelength stripline resonators 1431a, 1431b and one ½ wavelength stripline resonator 1401b placed in parallel to be electromagnetically coupled respectively. One end of the stripline resonator 1431a is connected to an unbalanced input (output) terminal 1405 via a coupling capacitance 1402, and the other end thereof forms the short circuit top end. Both ends of the stripline resonator 1401b are connected to balanced output (input) terminals 1406a and 1406b via coupling capacitances 1403a and 1403b respectively. Furthermore, inter-section coupling capacitances 1404a and 1404b are connected between the open ends of the stripline resonator 1431a and 1431b and between the open end of the stripline resonator 1431b and one end of the stripline resonator 1401b, and the other end of the stripline resonator 1431b forms the short circuit end.

Next, a description will be given as to the operation of the band-pass filter shown in FIG. 14. The signal inputted from the unbalanced terminal 1405 is conveyed to the stripline resonator 1431a via the coupling capacitance 1402. The stripline resonator 1431a operates as the short circuit end ¼ wavelength resonator, and the signal is conveyed to the stripline resonator 1431b via the first inter-section coupling capacitance 1404a. The stripline resonator 1431b also operates as the short circuit end ¼ wavelength resonator, and the signal is conveyed to the stripline resonator 1401b via the second inter-section coupling capacitance 1404b. The stripline resonator 1431a forms the filter having the attenuation pole together with the stripline resonator 1431b and its inter-section coupling capacitance 1404a. As the stripline resonator 1401b is the ½ wavelength resonator, the signal is outputted as the balanced signal to the balanced terminal. This configuration can realize the unbalanced-balanced band-pass filter. It is also possible to realize the same operation by further adding the ¼ wavelength stripline resonator or ½ wavelength stripline resonator via the inter-section coupling capacitance.

According to the configuration in FIG. 14, it is possible to realize the same unbalanced-balanced band-pass filter by constituting one ½ wavelength stripline resonator with two ¼ wavelength stripline resonators via a pair of inter-section coupling capacitances.

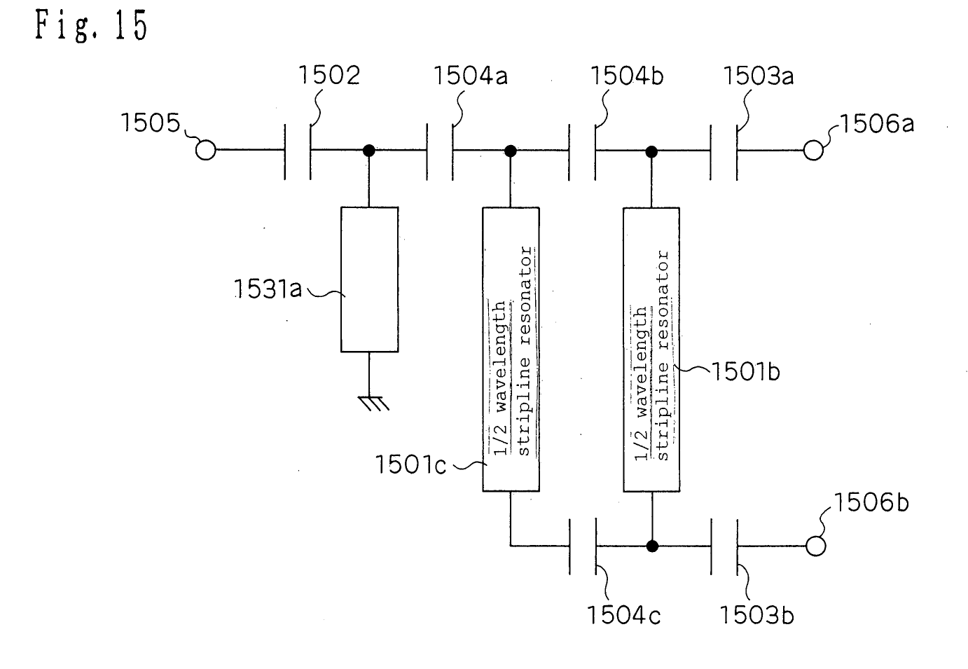

FIG. 15 is an equivalent circuit diagram comprised of the two ½ wavelength stripline resonators and one ¼ wavelength stripline resonator.

According to this configuration, there are one ¼ wavelength stripline resonator 1531a and two ½ wavelength stripline resonators 1501b and 1501c placed in parallel to be electromagnetically coupled respectively. One end of the stripline resonator 1531a is connected to an unbalanced input (output) terminal 1505 via a coupling capacitance 1502, and the other end thereof forms the short circuit end. Both ends of the stripline resonator 1501b are connected to balanced output (input) terminals 1506a and 1506b via coupling capacitances 1503a and 1503b respectively. Furthermore, inter-section coupling capacitances 1504a, 1504b and 1504c are connected between the open end of the stripline resonator 1531a and one end of the stripline resonator 1501c and between both ends of the stripline resonator 1501c and both ends of the stripline resonator 1501b respectively.

Next, the operation of the band-pass filter shown in FIG. 15 will be described. The signal inputted from the unbalanced terminal 1505 is conveyed to the stripline resonator 1531a via the coupling capacitance 1502. The stripline resonator 1531a operates as the short circuit end ¼ wavelength resonator, and the signal is conveyed to the stripline resonator 1501c via the first inter-section coupling capacitance 1504a. The stripline resonator 1501c operates as the open circuit end ½ wavelength resonator, and the signal is conveyed to the stripline resonator 1501b via the second inter-section coupling capacitances 1504b and 1504c. The stripline resonator 1531a forms the filter having the attenuation pole together with the 1501c and its inter-section coupling capacitance 1504a. As the stripline resonator 1501b is the ½ wavelength resonator, the signal conveyed to the stripline resonator 1501b is outputted as the balanced signal to the balanced terminals 1506a and 1506b.

This configuration can realize the unbalanced-balanced band-pass filter. Here, it is also possible to have the same effects by further placing the ½ wavelength stripline resonator via the inter-section coupling capacitance in addition.

It is possible to constitute any ½ wavelength stripline resonator in the configuration of the fifth embodiment with two ¼ wavelength stripline resonators.

As described above, as with the configurations according to the first to fourth embodiments of the present invention, the configuration according to the fifth embodiment has the characteristic close to the ideal balance characteristic, and its transmission characteristic has the band-pass filter characteristic having the attenuation pole. The laminated structure of the described configuration can have the number of components significantly smaller than the configuration in the past, and so it can realize the miniaturization as the configuration of the unbalanced-balanced laminated filter and significantly improve the loss in the pass band as to the transmission characteristic.

### Sixth Embodiment

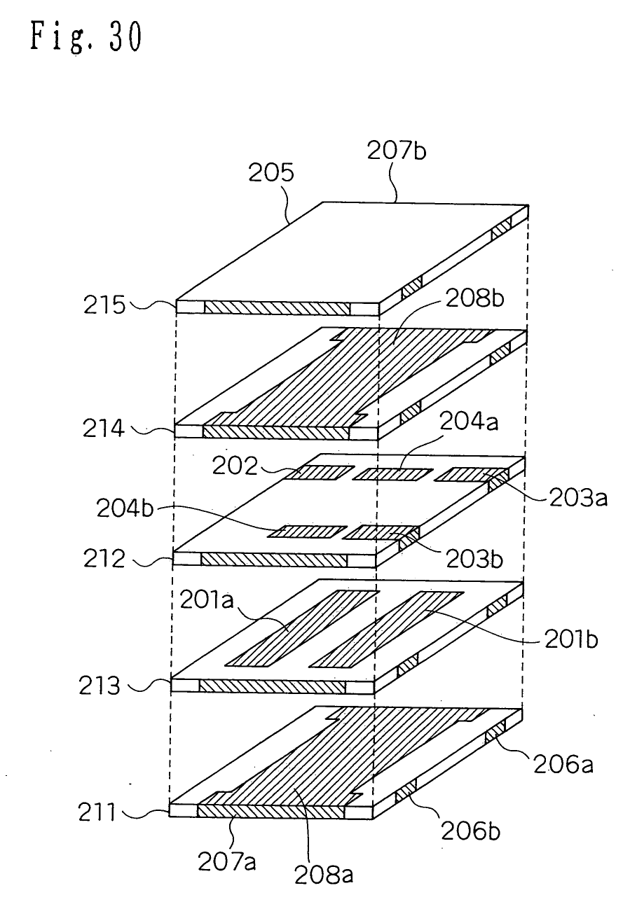

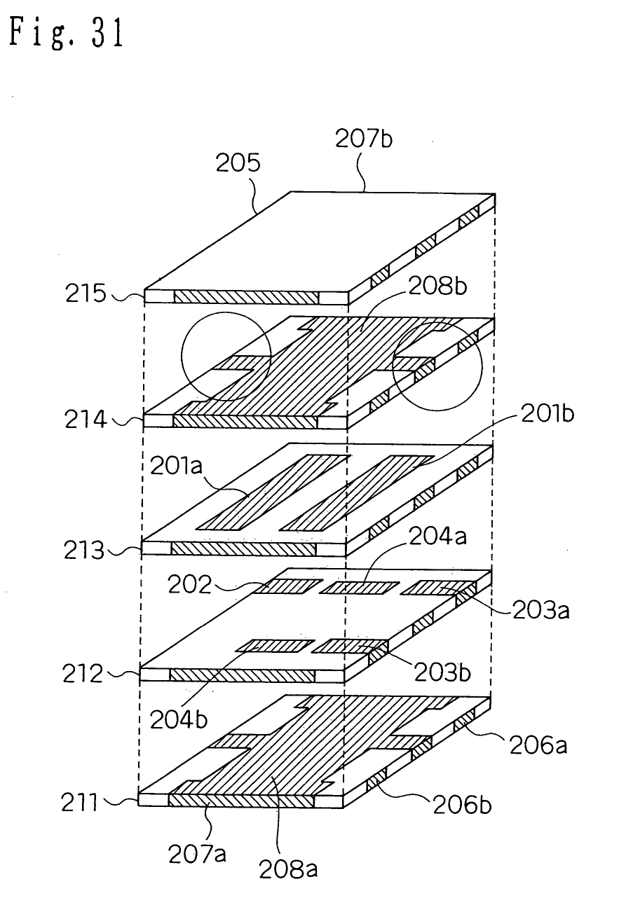

FIG. 30 shows the laminated structure of the band-pass filter according to the sixth embodiment of the present invention. The configuration of the band-pass filter shown in FIG. 30 is a reversal of vertical placement of the dielectric layers 213 and 212 in the laminated structure of the band-pass filter shown in FIG. 2. The first shield conductor 208a and second shield conductor 208b are connected by the external conductor electrodes 207a and 207b. According to this embodiment, however, the external conductor electrodes 207a and 207b have a width to be inductive and connect the first shield conductor 208a and second shield conductor 208b around the frequency to be used. To be more specific, the second shield conductor 208b is in a state of floating from the first shield conductor 208a by the amount of induction of the external conductor electrodes 207a and 207b. In this case, the second shield conductor 208b is sufficiently longer than the length of the stripline electrodes 201a and 201b (λ/2: λ is the wavelength of the resonant frequency).

According to this configuration, the second shield conductor 208b operates as a both top ends short circuit resonator. A resonant frequency f′ in this case is different from a resonant frequency f of the stripline electrodes 201a and 201b in the layer. The input-output stripline electrodes 202, 203a and 203b are placed below the second shield conductor 208b, and so parasitic capacitances are generated between the second shield conductor 208b and the input-output stripline electrodes 202, 203a and 203b respectively. Thus, the signal inputted from the input-output stripline electrodes 202, 203a or 203b around the resonant frequency of the second shield conductor 208b is propagated to the second shield conductor 208b via each parasitic capacitance. Therefore, the shield conductor 208b operates to form a new attenuation pole in the amplitude characteristic together with each parasitic capacitance.

According to this embodiment, it was described that the length of the second shield conductor 208b is sufficiently longer than the length of the stripline electrodes 201a and 201b (λ/2). In the case where such a condition is not satisfied, however, the attenuation pole is generated in the band of the unbalanced-balanced filter. To avoid such an attenuation pole in the band, it is necessary to increase the short circuit portions between the first shield conductor 208a and second shield conductor 208b. To be more specific, the width should be formed in the frequency to be used so that the external conductor electrodes 207a and 207b do not have an inductive component. For that purpose, for instance, there is a thinkable configuration wherein the first shield conductor 208a and second shield conductor 208b are connected via four conductors as shown in FIG. 31.

### Seventh Embodiment

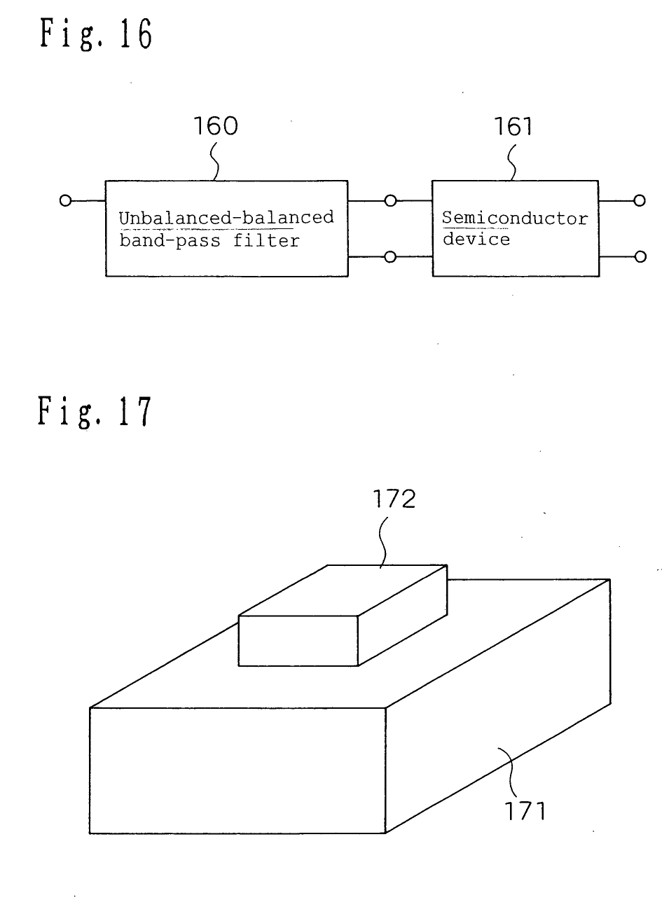

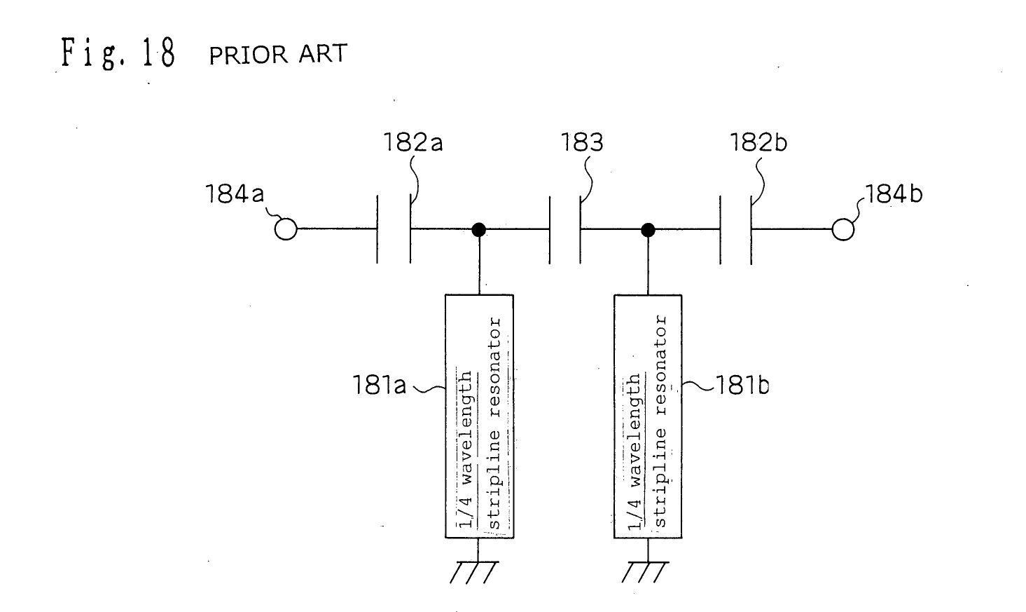

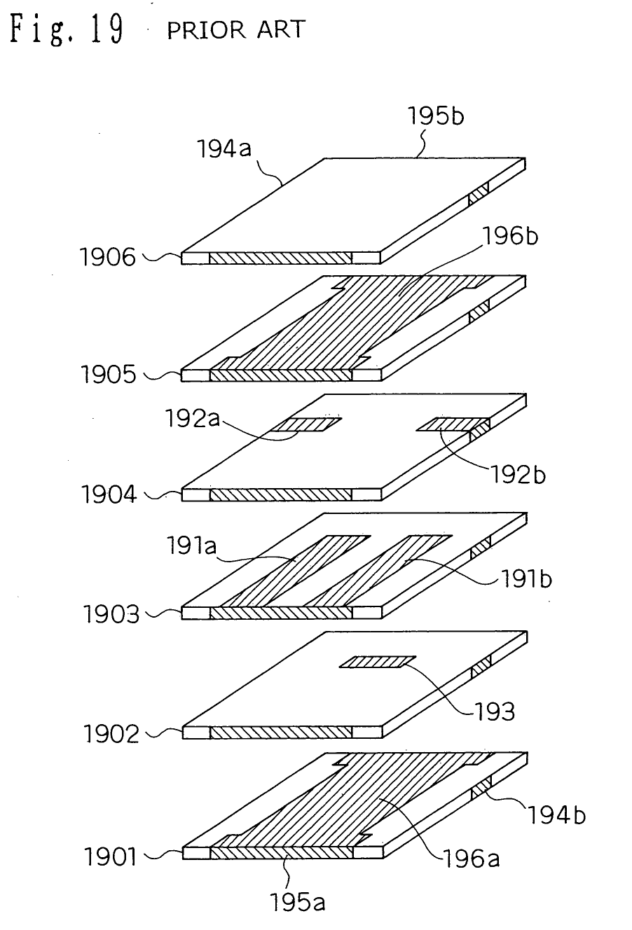

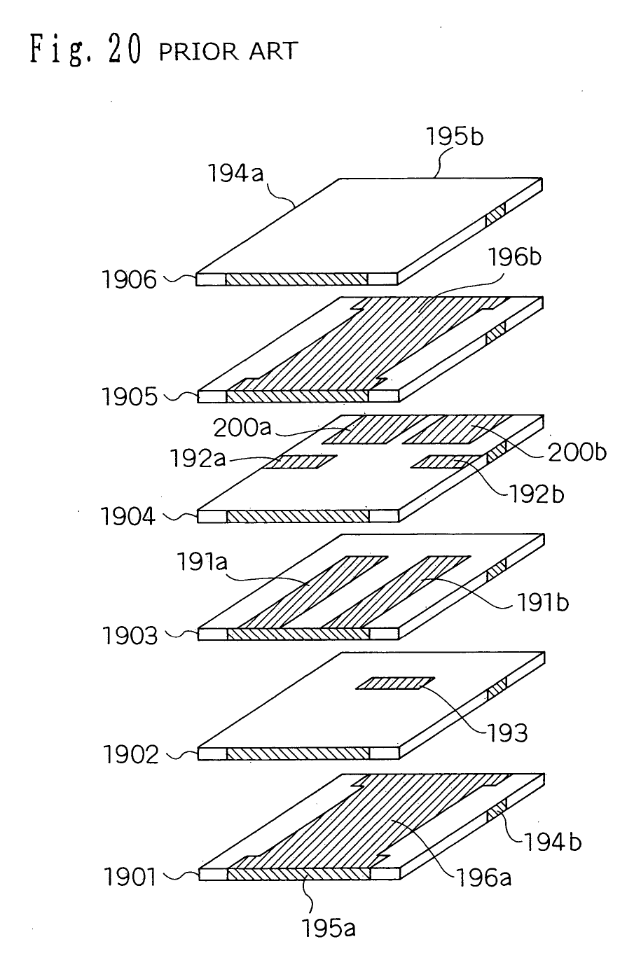

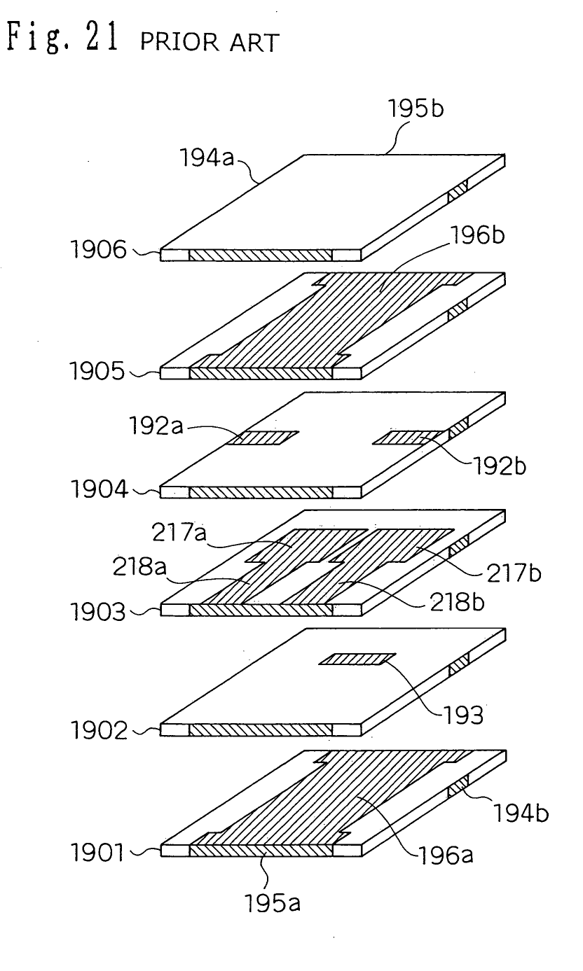

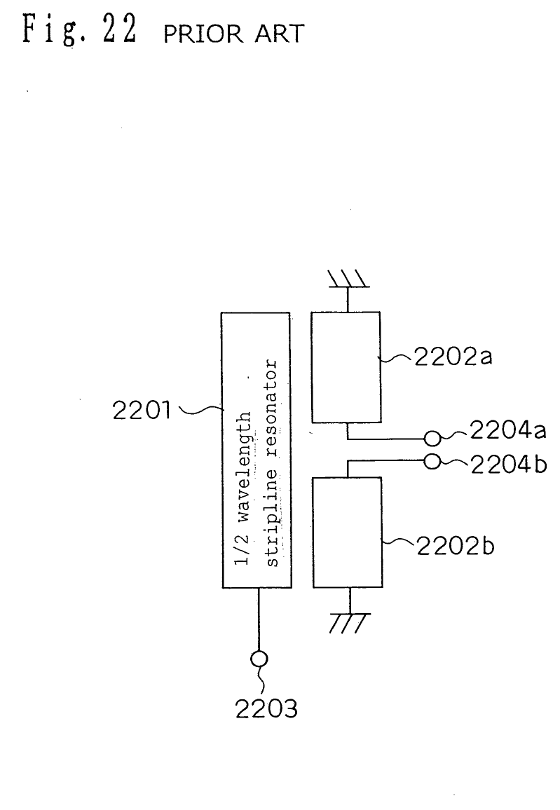

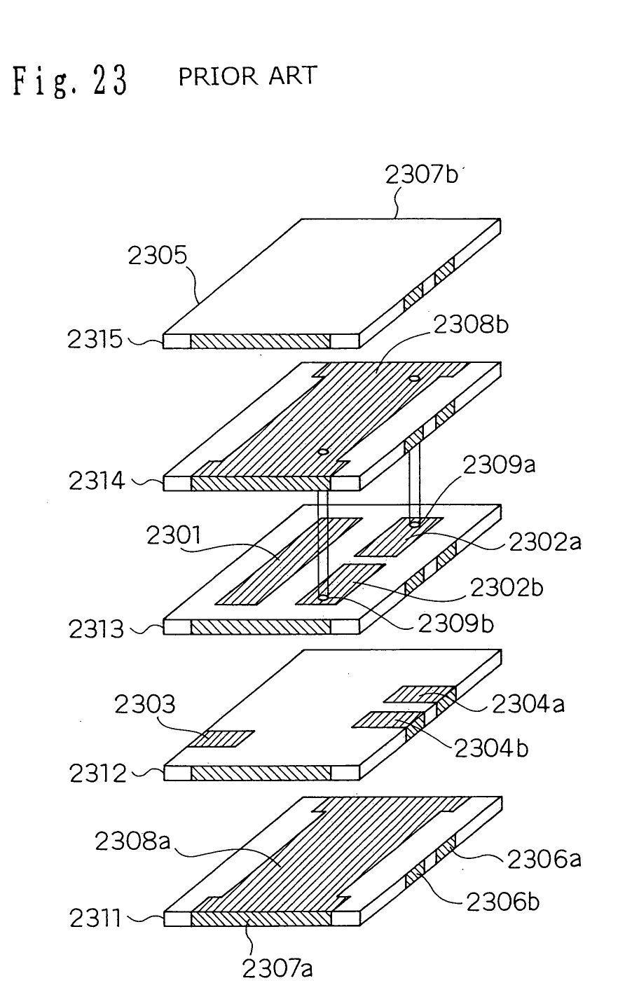

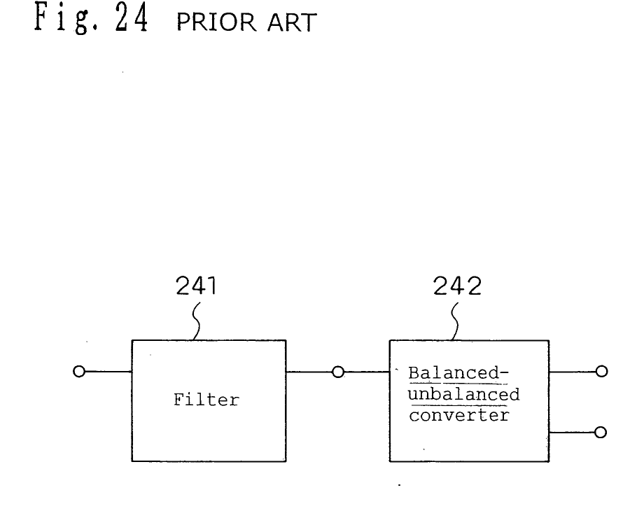

Here, FIG. 16 shows the configuration wherein the unbalanced-balanced filter according to the first to sixth embodiments and a semiconductor device for performing balanced operation are directly connected. This operation will be described next.

A semiconductor device 161 often connects a capacitor for interrupting a direct current to the inside or the outside. Here, all the configurations according to the first to sixth embodiments of the present invention are characterized by being connected to the balanced terminal via the coupling capacitance. Therefore, it is possible to directly connect an unbalanced-balanced band-pass filter 160 of the first to sixth embodiments to the semiconductor device 161 via no new capacitor for interrupting the direct current. For that purpose, the function of interrupting the direct current should be provided to at least one of the coupling capacitances corresponding to matching elements of the present invention by which each input terminal is connected to each stripline resonator and each output terminal is connected to each stripline resonator.

As shown in FIG. 17, it is possible to mount a semiconductor device 172 on an unbalanced-balanced laminated filter 171 according to the first to sixth embodiments. It is possible to mount the matching circuit of the semiconductor device 172 on or inside the laminated filter 171.

As described above, the configuration according to the seventh embodiment can connect the unbalanced-balanced laminated filter to the semiconductor device via no new capacitor for interrupting the direct current, and so reduction in the number of components can be expected.

### Eighth Embodiment

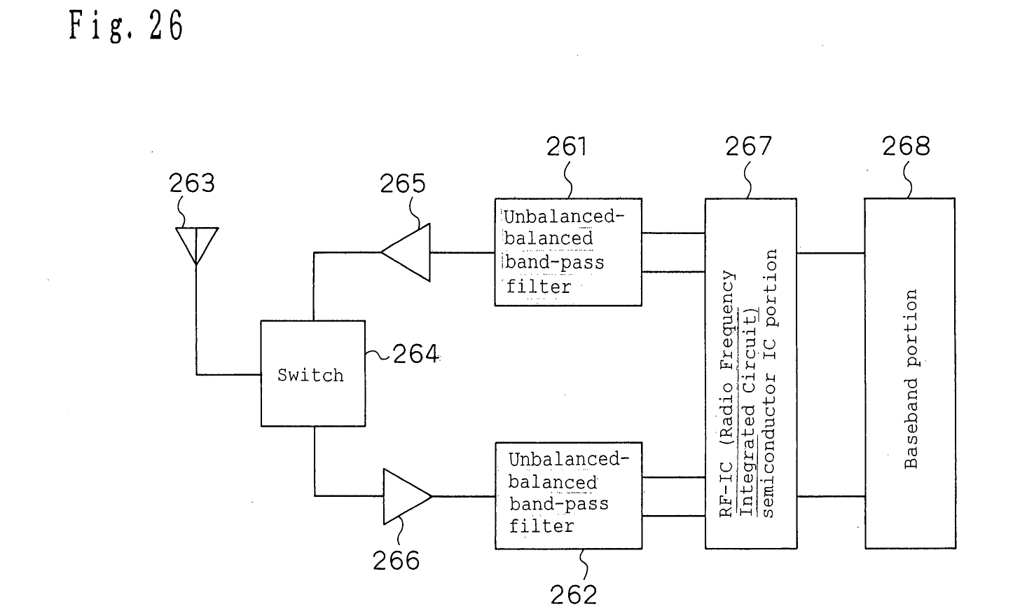

FIG. 26 shows a block diagram of a radio communication device using the unbalanced-balanced filter according to the first to sixth embodiments. Next, the operation of this configuration will be described.

In FIG. 26, a transmitting signal is modulated from a digital signal to an analog signal in a baseband portion 268, and the modulated analog signal is processed in a semiconductor IC portion 267, where the transmitting signal having performed the balanced operation is filtered by an unbalanced-balanced laminated filter 261 according to the first to sixth embodiments and conveyed to a transmitting amplifier 265. The transmitting signal amplified to a desired power level by the transmitting amplifier 265 is transmitted by being conveyed to a switch 264 and an antenna 263. The receiving signal received by the antenna 263 is conveyed to a receiving amplifier 266 by the switch 264, where the amplified signal is conveyed to an unbalanced-balanced laminated filter 262 according to the first to sixth embodiments so as to be filtered. The outputted receiving signal is processed in the semiconductor IC portion 267 and is conveyed to the baseband portion 268 so as to be signal-processed and demodulated into the digital signal.

As described above, it is possible to implement the radio communication device by using the unbalanced-balanced laminated filter according to the first to sixth embodiments.

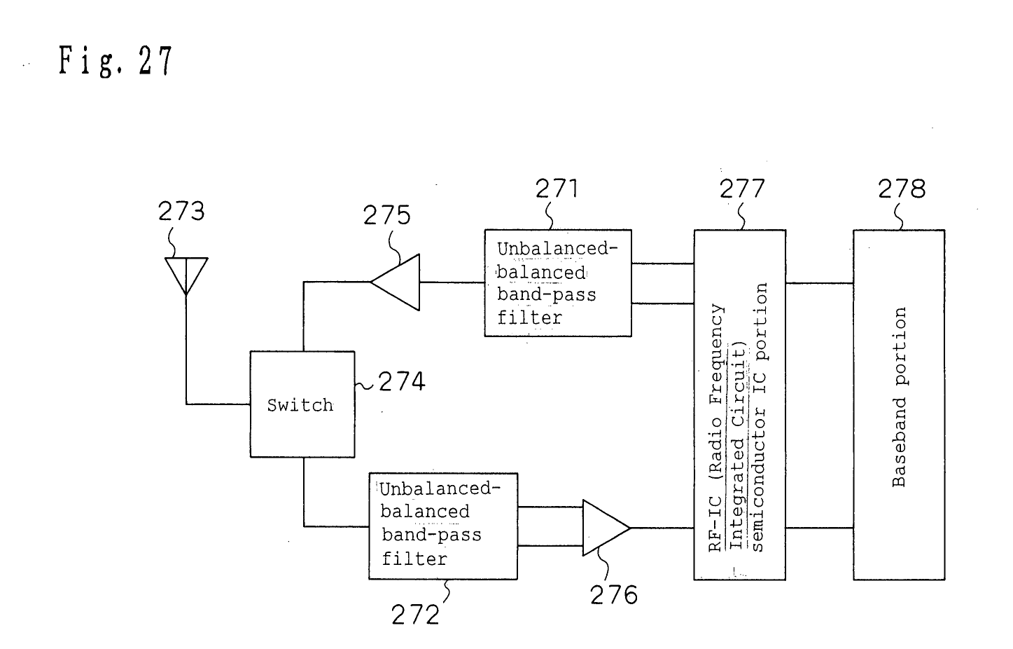

Here, as shown in FIG. 27, it is also possible to implement the same radio communication device by replacing the receiving amplifier 266 and unbalanced-balanced laminated filter 262 with the receiving amplifier 266 for processing the receiving signal and an unbalanced-balanced laminated filter 272 according to the first to sixth embodiments.

It is also possible to constitute as a module at least one of the unbalanced-balanced laminated filter 262 according to the first to sixth embodiments, transmitting amplifier 265, receiving amplifier 266 and semiconductor IC portion 267.

In the case where the unbalanced-balanced filter is required in a high-frequency circuit portion other than the radio communication device of the above described configuration, it is possible to implement it by using the unbalanced-balanced laminated filter according to the first to sixth embodiments or a modular configuration including it.

In the above description, an impedance element of the present invention is corresponding to the inter-section coupling capacitances 104a and 104b in the example shown in FIGS. 1 and 5, to the inter-section coupling capacitances 404a, 404b, 404c and 404d in the example shown in FIG. 4, to the inter-section coupling capacitances 804a and 804b in the example shown in FIG. 8, to the inter-section coupling capacitances 1004a and 1004b in the example shown in FIG. 10, to the inter-section coupling capacitances 1104a and 1104b in the example shown in FIG. 11, to the inter-section coupling capacitance 1204a in the example shown in FIG. 12, to the inter-section coupling capacitances 1404a and 1404b in the example shown in FIG. 14, and to the inter-section coupling capacitances 1504a, 1504b and 1504c in the example shown in FIG. 15.

In the above description, the first capacity element according to the present invention is corresponding to the inter-section coupling capacitance 104a in the examples shown in FIGS. 1 and 5, to the inter-section coupling capacitance 404a in the example shown in FIG. 4, to the inter-section coupling capacitance 804a in the example shown in FIG. 8, to the inter-section coupling capacitance 1004a in the example shown in FIG. 10.

The second capacity element according to the present invention is corresponding to the inter-section coupling capacitance 104b in the example shown in FIGS. 1 and 5, to the inter-section coupling capacitance 404b in the example shown in FIG. 4, to the inter-section coupling capacitance 804b in the example shown in FIG. 8, to the inter-section coupling capacitance 1004b in the example shown in FIG. 10.

The third capacity element according to the present invention is corresponding to the inter-section coupling capacitance 404c in the example shown in FIG. 4, to the inter-section coupling capacitance 1504b in the example shown in FIG. 15.

The fourth capacity element according to the present invention is corresponding to the inter-section coupling capacitance 404d in the example shown in FIG. 4.

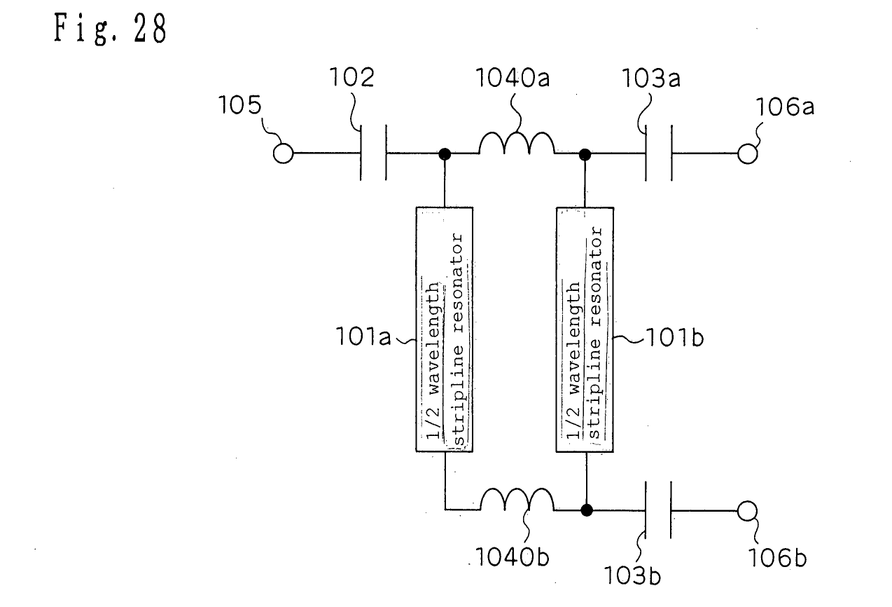

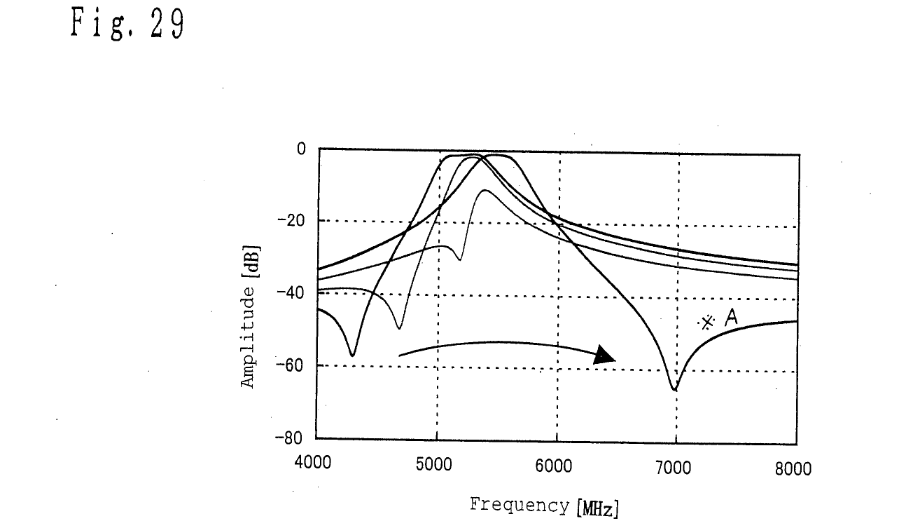

In the above description, it is described that the impedance element of the present invention is a capacity element as the coupling capacitance, but it is also thinkable that it is an inductive element. The equivalent circuit of the unbalanced-balanced filter in that case is as in FIG. 28 for instance. The example shown in FIG. 28 uses inter-section coupling inductances 1040a and 1040b instead of the inter-section coupling capacitances 104a and 104b shown in FIG. 1. FIG. 29 shows the transmission characteristic of the filter of the above configuration. It is possible, by rendering the impedance element of the present invention inductive, to form the attenuation pole on the high side of the pass band as shown by *A in FIG. 29. However, the inter-section coupling is determined by superposition with the electromagnetic coupling, and so the attenuation pole can be formed on the high side of the pass band when the results of the superposition are inductive even if there is a minute capacitance in between the sections. Inversely, even if there is a minute inductive element in between the sections, the attenuation pole can be formed on the low side of the pass band when the results of the superposition with the electromagnetic coupling are capacitive.

The first, second, third and fourth inductive elements according to the present invention are the first, second, third and fourth capacity elements replaced by inter-section coupling inductances respectively.

In the above description, the first stripline resonator of the present invention is corresponding to the stripline resonator 101a in the examples shown in FIGS. 1 and 5, to the stripline resonator 401a in the example shown in FIG. 4, to the stripline resonator 801a in the example shown in FIG. 8, to the stripline resonator 1001a in the examples shown in FIGS. 10 and 11, to the stripline resonator 1231a in the example shown in FIG. 12, to the stripline resonator 1431b in the example shown in FIG. 14, and to the stripline resonator 1531a in the example shown in FIG. 15 by way of example respectively.

The second stripline resonator of the present invention is corresponding to the stripline resonator 101b in the examples shown in FIGS. 1 and 5, corresponding to the stripline resonator 401c in the example shown in FIG. 4, to the stripline resonators 821a and 821b in the example shown in FIG. 8, to the series circuits of the stripline resonators 1021a and 1021b in the example shown in FIG. 10, to the stripline resonators 1121a and 1121b in the example shown in FIG. 11, to the stripline resonator 1201b in the example shown in FIG. 12, to the stripline resonator 1401b in the example shown in FIG. 14, and to the stripline resonator 1501c in the example shown in FIG. 15 by way of example respectively.

The third stripline resonator of the present invention is corresponding to the stripline resonator 401b shown in FIG. 4 by way of example.

The first and second capacity elements according to the present invention have the capacity for forming the attenuation pole outside the pass band of the filter of the present invention under the electromagnetic connection between the first stripline resonator and second stripline resonator of the present invention.

The third and fourth capacity elements according to the present invention have the capacity for forming the attenuation pole outside the pass band of the filter of the present invention, in collaboration with the first capacity element and/or second capacity element of the present invention, under the electromagnetic connection between the first stripline resonator and second stripline resonator and under the electromagnetic connection between the second stripline resonator and third stripline resonator of the present invention.

Likewise, the first to fourth inductive elements according to the present invention have the inductance for forming the attenuation pole outside the pass band of the filter of the present invention.

A first matching element of the present invention is corresponding to the coupling capacitance 102 in the examples shown in FIGS. 1 and 5, the coupling capacitance 402 in the example shown in FIG. 4, to the coupling capacitance 802 in the example shown in FIG. 8, to the coupling capacitance 1002 in the example shown in FIG. 10, to the coupling capacitance 1102 in the example shown in FIG. 11, to the coupling capacitance 1202 in the example shown in FIG. 12, to the coupling capacitance 1402 in the example shown in FIG. 14, and to the coupling capacitance 1502 in the example shown in FIG. 15 by way of example respectively.

A second matching element of the present invention is corresponding to the coupling capacitance 103a in the examples shown in FIGS. 1 and 5, the coupling capacitance 403a in the example shown in FIG. 4, to the coupling capacitance 803a in the example shown in FIG. 8, to the coupling capacitance 1003a in the example shown in FIG. 10, to the coupling capacitance 1103a in the example shown in FIG. 11, to the coupling capacitance 1203a in the example shown in FIG. 12, to the coupling capacitance 1403a in the example shown in FIG. 14, and to the coupling capacitance 1503a in the example shown in FIG. 15 by way of example respectively.

A third matching element of the present invention is corresponding to the coupling capacitance 103b in the examples shown in FIGS. 1 and 5, the coupling capacitance 403b in the example shown in FIG. 4, to the coupling capacitance 803b in the example shown in FIG. 8, to the coupling capacitance 1003b in the example shown in FIG. 10, to the coupling capacitance 1103b in the example shown in FIG. 11, to the coupling capacitance 1203b in the example shown in FIG. 12, to the coupling capacitance 1403b in the example shown in FIG. 14, and to the coupling capacitance 1503b in the example shown in FIG. 15 by way of example respectively.

There are thinkable cases, in the above embodiments, where the respective terminals and the respective stripline resonators are directly connected with no matching element. Even in such cases, the filter according to the present invention is the same as above as to the effects of having the balun function and being small-sized and high-performance.

In the examples shown in FIGS. 2, 30 and 31, the first electrode according to the present invention is corresponding to the inter-section stripline electrode 204a, the second electrode is corresponding to the inter-section stripline electrode 204b, the third electrode is corresponding to the input-output stripline electrode 202, the fourth electrode is corresponding to the input-output stripline electrode 203a, and the fifth electrode is corresponding to the input-output stripline electrode 203b.

While the above description states that the respective electrodes are formed on the respective surfaces of the dielectric layers, they may also be formed inside the respective dielectric layers.

As is clear from the above description, the present invention can significantly reduce the number of components compared to the past configuration wherein the unbalanced laminated filter and the balun are externally connected, and so it is expected to save the device area.

It is also expected to reduce the loss by optimizing a coupling capacitance value between the striplines.

According to the filter or filtering method of the present invention, it is possible to realize the small-sized and high-performance filter having the balun function, which is useful for the high-frequency modules and communication devices.

1-14. (canceled)

15. A filter having:
an unbalanced terminal;
a first stripline resonator of which one end is connected to said unbalanced terminal;
a second stripline resonator placed to be electromagnetically coupled and connected to said first stripline resonator via first impedance element and second impedance element; and
a balanced terminal which are connected to both ends of said second stripline resonator, wherein
said first impedance element connects a portion on said first stripline resonator having a first predetermined distance from one end thereof to a portion on said second stripline resonator having the first predetermined distance from either one of both ends thereof;
said second impedance element connects a portion on said first stripline resonator having a second predetermined distance from one end thereof to a portion on said second stripline resonator having the first predetermined distance from either one of both ends thereof;
the both of the first and second predetermined distances are 0.2 times or less of a wavelength of a resonance frequency;
the first predetermined distance and the second predetermined distance are different in length each other;
said second stripline resonator is a ½ wavelength resonator having substantial ½ length of a wavelength of a desired resonance frequency,
said unbalanced terminal and one end of said first stripline resonator are connected via a first matching element;
said balanced terminal and one end of said second stripline resonator are connected via a second matching element;
said balanced terminal and the other end of said second stripline resonator are connected via a third matching element; and
said first stripline resonator and said second stripline resonator are electromagnetically coupled, and said first stripline resonator and said second stripline resonator are connected via said first impedance element and said second impedance element, thereby an attenuation pole outside a pass band is formed.

16. A filter having:
an unbalanced terminal;
a first stripline resonator of which one end is connected to said unbalanced terminal;
a second stripline resonator placed to be electromagnetically coupled and connected to said first stripline resonator via first impedance element and second impedance element,
a third stripline resonator placed to be electromagnetically coupled and connected to said second stripline resonator via third impedance element and fourth impedance element; and
a balanced terminal which are connected to both ends of said second stripline resonator, wherein
said first impedance element connects a portion on said first stripline resonator having a first predetermined distance from one end thereof to a portion on said second stripline resonator having the first predetermined distance from either one of both ends thereof;
said second impedance element connects a portion on said first stripline resonator having a second predetermined distance from one end thereof to a portion on said second stripline resonator having the first predetermined distance from either one of both ends thereof;
said third impedance element connects a portion on said second stripline resonator having a third predetermined distance from one end thereof to a portion on said third stripline resonator having the third predetermined distance from either one of both ends thereof;
said fourth impedance element connects a portion on said second stripline resonator having a fourth predetermined distance from one end thereof to a portion on said third stripline resonator having the fourth predetermined distance from either one of both ends thereof;
all of the first, second, third, and fourth predetermined distances are 0.2 times or less of a wavelength of a resonance frequency;
at least in one of the pair of the first predetermined distance and the second predetermined distance and the pair of the third predetermined distance and the fourth predetermined distance, they are different in length each other;
said third stripline resonator is a ½ wavelength resonator having substantial ½ length of a wavelength of a desired resonance frequency.
said unbalanced terminal and one end of said first stripline resonator are connected via a first matching element;
said balanced terminal and one end of said third stripline resonator are connected via a second matching element;
said balanced terminal and the other end of said third stripline resonator are connected via a third matching element; and
said first stripline resonator and said second stripline resonator are electromagnetically coupled, and said first stripline resonator and second stripline resonator are coupled via said first impedance element and said second impedance element, and
said second stripline resonator and said third stripline resonator are electromagnetically coupled, and said second stripline resonator and said third stripline resonator are coupled via said third impedance element and said fourth impedance element, thereby an attenuation pole outside a pass band is formed.

17. The filter according to claim 15, wherein
said first stripline resonator and said second stripline resonator are formed on a surface or inside of the third dielectric layer,
said first impedance element is first capacity element;
said second impedance element is a second capacity element;
said first capacity element is formed among a first electrode portioned on a surface or inside of a second dielectric layer adjacent to said third dielectric layer, an electrode to form said first stripline resonator and an electrode to form said second stripline resonator,
said second capacity element is formed among a second electrode portioned on a surface or inside of a second dielectric layer adjacent to said third dielectric layer, the electrode to form said first stripline resonator and the electrode to form said second stripline resonator;
said first matching element is formed between a third electrode portioned on a surface or inside of a second dielectric layer and the electrode to form said first stripline resonator;
said second matching element is formed between a fourth electrode portioned on a surface or inside of a second dielectric layer and the electrode to form said second stripline resonator;
said third matching element is formed between a fifth electrode portioned on a surface or inside of a second (second) dielectric layer and the electrode to form said second stripline resonator;
said third and second dielectric layers are sandwiched between a first dielectric layer having a first shield conductor on a surface or inside thereof, and a fourth dielectric layer having a second shield conductor on a surface or inside thereof, which is connected to said first shield conductor; and
said first shield conductor and second electrode is connected on the predetermined impedance.

18. The filter according to claim 17. wherein
said third dielectric layer is laminated above said first dielectric layer;
said fourth dielectric layer is laminated above said second dielectric layer; and
the length in lengthening direction of said second shield conductor is longer than the length of said first stripline resonator so as to form the attenuation pole outside the pass band on the predetermined impedance.

19. A high-frequency module wherein a semiconductor device for performing a balance operation is laminated or internally layered in the filter according to claims 15 to 18.

20. A communication device having an antenna, a transmitting circuit connected to said antenna and a receiving circuit connected to said antenna, wherein at least one of said transmitting circuit and said receiving circuit has the filter according to claims 15 to 18.
